(19) United States
(12) Patent Application Publication
(10) Pub. No.: US 2025/0208529 A1
(43) Pub. Date: Jun. 26, 2025

(54) TONER

(71) Applicant: CANON KABUSHIKI KAISHA, Tokyo (JP)

(72) Inventors: YUHEI TERUI, Shizuoka (JP); TATSUYA SAEKI, Shizuoka (JP); MEGUMI YAMAUCHI, Shizuoka (JP)

(21) Appl. No.: 18/982,064

(22) Filed: Dec. 16, 2024

(30) Foreign Application Priority Data
Dec. 21, 2023 (JP) 2023-215503

(51) Int. Cl. G03G 9/087

(52) U.S. Cl. CPC G03G 9/08755; G03G 9/08782

(57) ABSTRACT

The toner comprising a toner particle comprising a binder resin and a wax, the binder resin comprises a polyester resin; the wax comprises a hydrocarbon wax and an ester wax; the ester wax comprises at least one compound selected from the group consisting of monoester compounds and diester compounds; the polyester resin comprises a polyester resin A comprising a specific amounts of a monomer unit corresponding to isophthalic acid and a monomer unit corresponding to dodecenylsuccinic acid; and the value of W1/W2, which is the ratio of the content WI of the hydrocarbon wax to the content W2 of the ester wax, is 0.15 to 0.80.

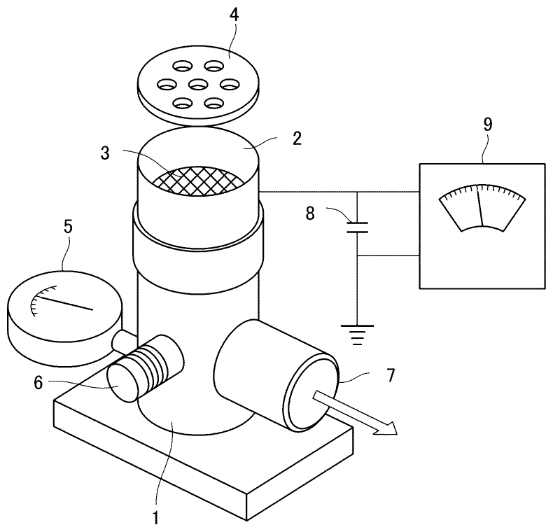

### BACKGROUND OF THE INVENTION

### Field of the Invention

The present disclosure relates to the toner for developing electrostatic images that is used in image-forming apparatuses, e.g., based on electrophotography or electrostatic printing.

### Description of the Related Art

Laser printers and copiers are examples of typical electrophotographic system-based devices that use toner. In recent years, in particular high productivities have been required of laser printers in addition to a stable image quality. In order to increase the productivity, the speed until the initial print out can be improved by achieving both an excellent charge rising performance and an excellent low-temperature fixability, while a stable image can be provided by maintaining the built-up charge.

The following, inter alia, are methods for improving the low-temperature fixability: designing a low glass transition temperature (Tg) for the toner binder resin; reducing the melt viscosity by, for example, lowering the molecular weight of the toner binder resin; and use of the plasticizing effect of a crystalline material that is compatible with the toner binder resin. However, a problem with these methods has been the occurrence of large changes in the charging performance after long-term storage caused by the appearance of relaxation phenomena of the toner binder resin itself and/or between the toner binder resin and the compatible material.

Japanese Patent Application Laid-open No. 2007-114398 essentially states that the image gloss value and the low-temperature fixability are improved by improving the compatibility with the crystalline material through the use of isophthalic acid or dodecenylsuccinic acid, and that the heat-resistant storage stability is improved by the adoption of a core-shell structure.

A hydrocarbon wax having a prescribed acid value and hydroxyl value is reacted into a polyester resin structure in Japanese Patent Application Laid-open No. 2015-210277. It is essentially stated that by doing this, the low-temperature fixability and hot offset resistance are improved by controlling the state of dispersion of the wax in the aggregated toner and thus improving the compatibility and separability between polyester resin and wax during fixing.

Japanese Patent Application Laid-open No. 2013-235248 essentially states that the heat-resistant storage stability and low-temperature fixability are improved by improving the compatibility with ester wax through the use of a polyester having a furan ring skeleton.

### SUMMARY OF THE INVENTION

However, there are problems with these publications with regard to obtaining additional increases in speed and a stable image quality.

For example, with regard to Japanese Patent Application Laid-open No. 2007-114398, in order to increase the shielding effect provided by the core-shell structure, a shell design having a high compatibility parameter (SP value) for the shell layer is required. Due to this, the compatibility between the shell material and the crystalline material, e.g., wax, is reduced and the low-temperature fixability may not be adequate to accommodate additional increases in speed. Moreover, by disposing polyester resin having a high compatibility parameter (SP value) at the toner particle surface, when continuous printing is continued, the toner charge then continues to rise, which can cause the occurrence of image defects.

Japanese Patent Application Laid-open No. 2015-210277 made it possible to achieve both an enhanced state of dispersion for the wax and an enhanced compatibility and separability for the added wax. However, due to the enhanced compatibility, an uncrystallized compatible wax component ends up being present in large amounts after the toner has been produced. Due to this, the compatible wax component transfers to the toner surface when long-term storage of the toner is carried out, resulting in a substantial decline in the charging performance.

According to Japanese Patent Application Laid-open No. 2013-235248, the heat-resistant storage stability and the compatibility between polyester resin and wax are improved by changing the polyester composition. However, while the impact of a high-temperature environment is lessened, when long-term storage is carried out, just as in Japanese Patent Application Laid-open No. 2015-210277 the charging performance is substantially reduced by transfer of a compatible wax component to the toner surface.

The present disclosure relates to a toner that exhibits an excellent charge rising performance and low-temperature fixability and that can continuously provide a stable image by exhibiting a stable charging performance even during continuous printing and also by having a stable charging performance even when long-term storage has been carried out.

The present disclosure relates to a toner comprising a toner particle comprising a binder resin and a wax, the binder resin comprises a polyester resin;
the wax comprises a hydrocarbon wax and an ester wax;
the ester wax comprises at least one compound selected from the group consisting of monoester compounds and diester compounds;
the polyester resin comprises a polyester resin A comprising a monomer unit corresponding to isophthalic acid and a monomer unit corresponding to dodecenylsuccinic acid;
a content in the polyester resin A of the monomer unit corresponding to isophthalic acid is 15.0 to 30.0 mass %;
a content in the polyester resin A of the monomer unit corresponding to dodecenylsuccinic acid is 3.0 to 20.0 mass %; and
when W1 denotes a content of the hydrocarbon wax per 100 parts by mass of the binder resin and W2 denotes a content of the ester wax per 100 parts by mass of the binder resin, the value of a ratio W1/W2 is 0.15 to 0.80.

The present disclosure can thus provide a toner that exhibits an excellent charge rising performance and low-temperature fixability and that can continuously provide a stable image quality by exhibiting a stable charging performance even during continuous printing and also by having a stable charging performance even when long-term storage has been carried out.

Further features of the present invention will become apparent from the following description of exemplary embodiments with reference to the attached drawings.

### BRIEF DESCRIPTION OF THE DRAWINGS

The FIGURE is a device for measuring the charge quantity in the present disclosure.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined.

In addition, in the present disclosure, for example, descriptions such as “at least one selected from the group consisting of XX, YY and ZZ” mean any of XX, YY, ZZ, the combination of XX and YY, the combination of XX and ZZ, the combination of YY and ZZ, and the combination of XX, YY, and ZZ.

In order to obtain a toner that exhibits an excellent low-temperature fixability and an excellent image stability, the present inventors carried out intensive and extensive investigations into wax crystallization and wax compatibility relative to polyester resins. In particular, the present inventors discovered that the above-described problems with low-temperature fixability and a stable charging performance can be solved by controlling the content of monomer units corresponding to prescribed acids that are used in the polyester resin and controlling the content ratio between a hydrocarbon wax and a prescribed ester wax.

Namely, the present disclosure relates to a toner comprising a toner particle comprising a binder resin and a wax, the binder resin comprises a polyester resin;
the wax comprises a hydrocarbon wax and an ester wax;
the ester wax comprises at least one compound selected from the group consisting of monoester compounds and diester compounds;
the polyester resin comprises a polyester resin A comprising a monomer unit corresponding to isophthalic acid and a monomer unit corresponding to dodecenylsuccinic acid;
a content in the polyester resin A of the monomer unit corresponding to isophthalic acid is 15.0 to 30.0 mass %;
a content in the polyester resin A of the monomer unit corresponding to dodecenylsuccinic acid is 3.0 to 20.0 mass %; and
when W1 denotes a content of the hydrocarbon wax per 100 parts by mass of the binder resin and W2 denotes a content of the ester wax per 100 parts by mass of the binder resin, the value of a ratio W1/W2 is 0.15 to 0.80.

The binder resin in the toner according to the present disclosure comprises a polyester resin A that is a polyester resin comprising a monomer unit corresponding to isophthalic acid and a monomer unit corresponding to dodecenylsuccinic acid. The compatibility between the wax and binder resin is improved by the polyester resin A. The monomer unit corresponding to isophthalic acid comprises aromaticity and makes a substantial contribution to maintenance of the charging performance. The effect of maintaining the charging performance can also be obtained using a monomer unit corresponding to terephthalic acid, with its similar structure, as an acid component.

However, as compared to polyester resin having a monomer unit corresponding to isophthalic acid, it is thought that terephthalic acid, because it has a linear structure for its molecular structure, causes a poorer compatibility with other molecules due to an inferior molecular mobility. Due to this, the compatibility with, e.g., ester waxes, is insufficient and the low-temperature fixability may become inadequate. On the other hand, due to the low structural polarity as a consequence of the alkyl chain, the monomer unit corresponding to dodecenylsuccinic acid can provide the effect of increasing the compatibility with low-polarity materials, e.g., ester waxes. In particular, a higher compatibility can be exhibited because the alkyl chain of dodecenylsuccinic acid is present as a side chain in the polyester resin.

For these reasons, the polyester resin A according to the present disclosure is a polyester resin that achieves both a high compatibility and a charging performance based on an excellent charge retention performance. However, the present inventors recognized that with just the aforementioned design alone it was still difficult to obtain toner that also had a stable charging performance after long-term storage. Specifically, there were instances in which the state of occurrence of the wax was not stable. The present inventors therefore undertook to improve the charge stability after long-term storage by the co-use, with an ester wax having an excellent compatibility with the polyester resin A, of a strongly crystalline hydrocarbon wax.

As a result, the present inventors discovered that very stable charging characteristics even upon long-term storage are obtained in addition to obtaining an excellent low-temperature fixability by controlling the contents of the aforementioned monomer units and then also using, as the wax, a combination of hydrocarbon wax with an ester wax selected from the group consisting of monoester compounds and diester compounds and controlling the content ratio of these waxes.

The present inventors hypothesize that these effects arise due to the following mechanisms. The polyester resin having a monomer unit corresponding to isophthalic acid also exhibits an excellent molecular mobility while having excellent charging performances. As a consequence, in a state in which the polyester resin A and wax are compatible with each other, the wax molecules can easily approach the polyester resin A and a strong interaction is expressed.

With regard to the monomer unit corresponding to dodecenylsuccinic acid, on the other hand, interaction with the hydrocarbon wax is facilitated due to the presence of the long-chain alkyl group and the formation of nuclei due to hydrocarbon wax crystals is then facilitated. In addition, crystallization of the ester wax is promoted by the nuclei due to hydrocarbon wax crystals, and crystallization then goes forward. It is hypothesized, based on the mechanisms described in the preceding, that crystallization of the wax proceeds rapidly from a state of high compatibility, that even immediately after toner production the wax component compatible with the polyester resin A is small, and that changes in the charging performance do not occur even after long-term storage because the state of occurrence of the wax is stable.

As a consequence, the content in the polyester resin A of monomer unit corresponding to isophthalic acid (also referred to herebelow as the isophthalic acid unit) is required to be 15.0 to 30.0 mass %. When the isophthalic acid unit is less than 15.0 mass %, the molecular mobility of the polyester resin A is insufficient and interaction with the wax component is inadequate and the crystallization rate is not adequate, and as a consequence the charging performance after long-term storage ends up undergoing changes. When, on the other hand, the isophthalic acid unit content exceeds 30.0 mass %, while the molecular mobility is excellent, the compatibility with the wax ends up increasing and as a consequence an uncrystallizable component is formed in the ester wax and the charging performance after long-term storage is impaired.

As a consequence, the isophthalic acid unit content in the polyester resin A is required to be 15.0 to 30.0 mass % and is preferably 18.0 to 28.0 mass % and more preferably 20.0 to 25.0 mass %. When this range is observed, the compatibility with the ester wax is excellent, the low-temperature fixability is excellent, and the production of nuclei due to the hydrocarbon wax is facilitated, and as a consequence a toner can be obtained that exhibits little change in charging after long-term storage.

The isophthalic acid unit content in the polyester resin A can be controlled using the amount of addition of isophthalic acid, which is a polybasic carboxylic acid component used when the polyester resin is obtained.

The content in the polyester resin A of monomer unit corresponding to dodecenylsuccinic acid (also referred to herebelow as the dodecenylsuccinic acid unit) is required to be 3.0 to 20.0 mass %. When the content of dodecenylsuccinic acid unit is less than 3.0 mass %, the compatibility with the ester wax is insufficient and as a consequence a satisfactory low-temperature fixability cannot be obtained.

When, on the other hand, the dodecenylsuccinic acid unit exceeds 20.0 mass %, it is thought that the compatibility of the wax with the polyester resin A is too high and that as a consequence crystallization does not advance and the charging performance after long-term storage then undergoes changes.

Due to this, the content of the dodecenylsuccinic acid unit in the polyester resin A is required to be 3.0 to 20.0 mass % and is preferably 5.0 to 18.0 mass % and more preferably 7.0 to 15.0 mass %.

The dodecenylsuccinic acid unit content in the polyester resin A can be controlled using the amount of addition of dodecenylsuccinic acid, which is a polybasic carboxylic acid component used when the polyester resin is obtained.

The monomer unit corresponding to isophthalic acid in the polyester resin A is a structure in which isophthalic acid has formed an ester bond, and, for example, is represented by the following formula (I). The monomer unit corresponding to dodecenylsuccinic acid in the polyester resin A is a structure in which dodecenylsuccinic acid has formed an ester bond, and, for example, is represented by the following formula (D).

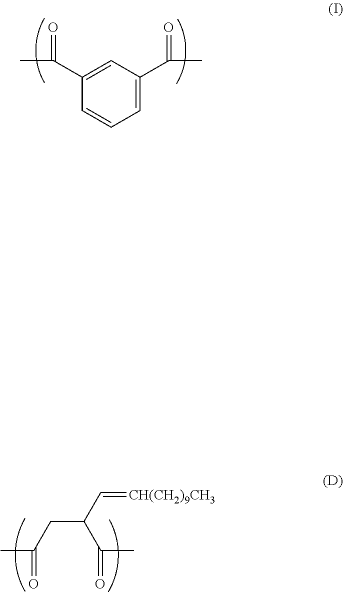

The value of W1/W2, which is the ratio of the content W1 of the hydrocarbon wax per 100 parts by mass of the binder resin to the content W2 of the ester wax per 100 parts by mass of the binder resin, is required to be 0.15 to 0.80. When W1/W2 is less than 0.15, there is little hydrocarbon wax, which becomes the nuclei of the wax crystals, and as a consequence crystallization of the ester wax cannot be promoted and the charging performance after long-term storage thus ends up undergoing large changes.

When, on the other hand, W1/W2 is larger than 0.80, the proportion of the hydrocarbon wax is then too large and as a consequence the occurrence of crystallization of the hydrocarbon wax by itself is facilitated, interaction of the hydrocarbon wax with the dodecenylsuccinic acid unit is impeded, and only the ester wax interacts with the dodecenylsuccinic acid unit. As a consequence, the ester wax readily retains a state of compatibility with the polyester resin A and the development of crystallization of the ester wax ends up being impeded, and due to this changes in the charging performance after long-term storage cannot be inhibited.

As a consequence, the value of the ratio W1/W2 is required to be 0.15 to 0.80 and is preferably 0.20 to 0.70 and more preferably 0.25 to 0.55.

The molecular weight of the ester wax is preferably 500 to 1,000 and is more preferably 600 to 900. A wax with a molecular weight in the indicated range exhibits an excellent compatibility with the polyester resin A and an excellent crystallization rate from the compatible state.

In the present disclosure, the molecular weight of the ester wax is the value provided by calculation of the molecular weight from the structure of the ester wax. In addition, when a molecular weight distribution is present, e.g., an ester wax derived from a natural product or a synthetic wax that uses, in the monomer component, monomer derived from a natural product or from a polymer, the peak molecular weight in the molecular weight distribution provided by GPC analysis is used as the molecular weight of the ester wax.

The content W1 of the hydrocarbon wax per 100 parts by mass of the binder resin is, for example, 0.5 to 12.0 parts by mass and is preferably 0.5 to 7.0 parts by mass. When the indicated range is observed, the nuclei of hydrocarbon wax that are produced in the toner are formed in more suitable amounts and crystallization of the ester wax can be further promoted. W1 is more preferably 1.0 to 5.0 parts by mass and is still more preferably 1.5 to 4.5 parts by mass.

The content W2 of the ester wax per 100 parts by mass of the binder resin is, for example, 2.0 to 33.0 parts by mass and is preferably 3.0 to 20.0 parts by mass. When the indicated range is observed, the compatibility with the polyester resin A is excellent and the low-temperature fixability is even better. In addition, when the indicated range is observed, the ester wax then readily separates from the state of compatibility in the polyester resin A and crystallization is promoted even further. W2 is more preferably 5.0 to 17.5 parts by mass and still more preferably 7.5 to 15.0 parts by mass.

In addition, the binder resin may comprise a resin other than the polyester resin A. In this case, the content of the polyester resin A, with reference to the mass of the binder resin, is preferably 50.0 to 100.0 mass %, more preferably 60.0 to 100.0 mass %, still more preferably 70.0 to 100.0 mass %, and even more preferably 85.0 to 100.0 mass %. A polyester resin other than the polyester resin A may be used in addition to the polyester resin A. The content of the polyester resin A in the polyester resin is preferably 50.0 to 100.0 mass %, more preferably 75.0 to 100.0 mass %, still more preferably 80.0 to 100.0 mass %, and even more preferably 90.0 to 100.0 mass %. The generation of an even better low-temperature fixability and charging performance is facilitated when the indicated ranges are observed.

The content, with reference to the mass of the binder resin, of the monomer unit corresponding to dodecenylsuccinic acid is, for example, 1.5 to 20.0 mass %, preferably 3.0 to 20.0 mass %, and more preferably 5.0 to 15.0 mass %. A more stable charging performance after long-term storage is obtained when the indicated range is observed.

The content of the dodecenylsuccinic acid unit can be controlled by adjusting the contents of the polyester resin A and other resin that are used when the toner particle is produced.

The ester wax comprises at least one compound selected from the group consisting of monoester compounds and diester compounds. Preferably the ester wax comprises a monoester compound and the monoester compound comprises a compound given by the following formula (1).

R¹—COO—R² . . . (1)

(R¹ and R² each independently represent an alkyl group having 18 to 24 (preferably 18 to 22 and more preferably 20 to 22) carbons.)

An ester wax with the structure in formula (1) exhibits an excellent crystallization because the alkyl chain length is sufficiently long, and in addition the proportion for the ester group is sufficient for compatibilization with the polyester resin A. Moreover, because it also has an excellent mobility in the binder resin due to it being an ester wax structure having a relatively small molecular weight, interaction with the crystal nucleus component originating with the hydrocarbon wax is facilitated.

In addition, the toner particle preferably comprises a compound A that is at least one compound selected from the group consisting of compounds given by the following formula (2) and compounds given by the following formula (3).

R³—O—(A¹-O)ₙ—X . . . (2)

(In formula (2), R³ represents an alkyl group having 8 to 24 carbons; A¹ represents an ethylene group (—CH₂CH₂—) or propylene group (—CH(CH₃)CH₂—); n is an integer from 5 to 60; and X is H, CH₂COOH, CH₂SO₃H, CH₂COONa, or CH₂SO₃Na.)

R⁴-Ph—O—(A²-O)ₘX . . . (3)

(In formula (3), R⁴ represents an alkyl group having 8 to 24 carbons; Ph represents a phenylene group; A² represents an ethylene group or propylene group; m represents an integer from 5 to 60; and X is H, CH₂COOH, CH₂SO₃H, CH₂COONa, or CH₂SO₃Na.)

From the standpoint of improving the long-term storability, the crystallinity of the hydrocarbon wax and ester wax in the toner particle is preferably increased. When the crystallinity of the wax is increased, saturation of the charge quantity during repetitive continuous printing is impaired and the charge quantity may vary. The toner particle therefore preferably comprises the compound A. When the compound A is present, an even better charge stability is obtained during repetitive continuous printing.

This is attributed to an improvement in charge mobility within the toner particle, deriving from the polyether structure of the compound A. In accordance with the structure in formula (2) or (3), the affinity with the polyester resin A is high and interaction of the polyether segment is suitably expressed. As a consequence, from the standpoint of the affinity with the polyester resin A, the R³ in formula (2) is preferably an alkyl group having from 8 to 24 carbons with from 10 to 18 being more preferred. The R⁴ in formula (3) is preferably an alkyl group having from 8 to 24 carbons with from 9 to 12 being more preferred.

In order to obtain a better charge mobility within the toner particle, n in formula (2) is preferably from 5 to 60, more preferably from 6 to 30, and still more preferably from 8 to 20. In addition, m in formula (3) is preferably from 5 to 60, more preferably from 6 to 30, and still more preferably from 8 to 20.

With reference to the mass of the toner, the amount of extraction of the compound A extracted from the toner using ethanol is, for example, 10 to 2,000 ppm and is preferably 10 to 1,000 ppm. Charge is produced in the toner by triboelectric charging of the toner particle surface. When the extraction amount for compound A is in the indicated range, the produced charge becomes uniform at the toner particle surface and in addition excess charge can be efficiently released. The above amount of extraction of the compound A is preferably 30 to 500 ppm and more preferably 50 to 300 ppm.

The extraction amount for the compound A is adjusted in correspondence to the amount of addition of the compound A that is added during the toner production process. With regard to the timing of the addition of the compound A, it may be added during the toner particle production process or may be added after toner particle production. Addition during the toner particle production process is preferred from the standpoint of improving the interaction with the polyester resin A, and the addition of the compound A to an aqueous medium is preferred from the standpoint of bringing about a uniform occurrence at the toner particle surface.

In a cross-sectional observation of the toner using a transmission electron microscope, As is defined as the average proportion for the area taken up by domains due to the wax in the surface layer region from the surface of the toner particle to a depth of 200 nm. Using this definition, As is, for example, 0.0 to 5.0 area % and is preferably 0.0 to 1.0 area %. An As of 0.0 to 1.0 area % thus indicates that there is little wax in the vicinity of the toner particle surface.

In the present disclosure, by promoting crystallization of the ester wax, the state of occurrence of the wax after long-term storage is stabilized and changes in the charging performance are suppressed; however, bringing about a complete crystallization of the ester wax is difficult. In particular, a compatible component of the ester wax may remain at the peripheries of the wax domains, and as a consequence transfer of the compatible component to the toner particle surface can be better suppressed by having As be 0.0 to 1.0 area %. 0.0 to 0.5 area % is more preferred for As.

The As can be adjusted by controlling the amount of wax addition and by forming a core-shell structure in the toner particle and controlling the thickness of the shell layer.

The toner particle preferably comprises the boron atom. When the boron atom content is 1.0 to 100.0 mass-ppm with reference to the mass of the toner particle, this facilitates obtaining a toner that has a better charge stability when submitted to long-term storage and a better charge rising performance. The boron atom has a large ionization potential and readily forms a covalent bond and as a consequence is thought to interact with the large number of ester groups present in the polyester resin A. It is thought that as a result the boron atom readily disperses in the boron atom-comprising polyester resin A and charge retention by the toner is then improved. In addition, it is thought that, through the formation of a boron atom-mediated pseudo-crosslinked state based on interactions between boron atoms and the large number of ester groups present in the polyester resin A, movement of the uncrystallizable or not fully crystallized ester wax is inhibited and a toner having a better long-term storability is then obtained.

The boron atom content with reference to the mass of the toner particle is more preferably 1.0 to 30.0 mass-ppm and still more preferably 3.0 to 15.0 mass-ppm. The boron atom can be introduced into the toner particle by the addition of a boron atom-comprising compound during the toner particle production process, and the amount present can be adjusted using the amount of addition of the boron atom-comprising compound.

### Constituent Components of the Toner

The individual components making up the toner and the toner production method are described in greater detail in the following.

### Binder Resin

The toner particle comprises a binder resin. The binder resin comprises a polyester resin. The polyester resin comprises the polyester resin A. As previously indicated, the binder resin may comprise a resin other than the polyester resin. The binder resin preferably comprises 50 mass % or more polyester resin. The polyester resin content in the binder resin is preferably 50.0 to 100.0 mass %, more preferably 70.0 to 100.0 mass %, still more preferably 80.0 to 100.0 mass %, and even more preferably 90.0 to 100.0 mass %. A better low-temperature fixability and a better charging performance are readily obtained when this range is observed. Binder resins other than the polyester resin A are exemplified by the following.

The binder resin is not particularly limited, and examples thereof include styrene acrylic resin, polyester resin, epoxy resin, polyurethane resin, polyamide resin, cellulose resin, polyether resin, mixed resins and composite resins thereof, and the like. Styrene acrylic resin and polyester resin are preferable because they are inexpensive, easily available, and enable excellent low-temperature fixability.

The polyester resin such as polyester resin A can be obtained by selecting and combining suitable components from among polyvalent carboxylic acids, polyols, hydroxycarboxylic acids, and the like, and performing synthesis by using a conventionally known method such as a transesterification method or a polycondensation method.

A polyvalent carboxylic acid is a compound containing two or more carboxy groups in one molecule. Of these, a dicarboxylic acid, which is a compound comprising two carboxy groups in one molecule, is preferably used.

The polyester resin A must comprise, as polybasic acids, from 15.0 to 30.0 mass % isophthalic acid unit and from 3.0 to 20.0 mass % dodecenylsuccinic acid unit. The isophthalic acid unit content, in 100 mol % for the polybasic carboxylic acid component of the polyester resin A, is preferably from 40 to 90 mol % and is more preferably from 50 to 80 mol %. The dodecenylsuccinic acid unit content, in 100 mol % for the polybasic carboxylic acid component of the polyester resin A, is preferably from 5 to 40 mol % and is more preferably from 10 to 25 mol %.

Polybasic carboxylic acids in the polyester resin A other than the aforementioned polybasic carboxylic acids can be exemplified as follows.

Dicarboxylic acids can be exemplified by dicarboxylic acids such as oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexα-3,5-diene-1,2-dicarboxylic acid, hexahydroterephthalic acid, malonic acid, pimelic acid, suberic acid, phthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

Examples of the polyvalent carboxylic acid other than the dicarboxylic acid include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid and the like. These may be used alone or in combination of two or more.

A polyol is a compound containing two or more hydroxyl groups in one molecule. Of these, a diol, which is a compound containing two hydroxyl groups in one molecule, is preferably used.

Specific examples include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, diethylene glycol, triethylene glycol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, 1,4-cyclohexanediol, polytetramethylene glycol, hydrogenated bisphenol A, bisphenol A, bisphenol F, bisphenol S, alkylene oxide (ethylene oxide, propylene oxide, butylene oxide, and the like) adducts of the above bisphenols, and the like.

Of these, the preferred are alkylene glycols having 2 to 12 carbon atoms and alkylene oxide adducts of bisphenols, and particularly preferable ones are alkylene oxide adducts of bisphenols and combinations thereof with alkylene glycols having 2 to 12 carbon atoms.

Examples of trivalent or higher polyols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolak, alkylene oxide adducts of the above trivalent or higher polyphenols, and the like. These may be used alone or in combination of two or more.

The polybasic carboxylic acid may comprise, in addition to dodecenylsuccinic acid and isophthalic acid, at least one selection from the group consisting of terephthalic acid, sebacic acid, and trimellitic acid, and preferably comprises at least one selection from the group consisting of sebacic acid and trimellitic acid.

In addition, the polyol more preferably comprises at least one selection from the group consisting of alkylene glycols having 2 to 6 carbons and the adducts (for example, 1 to 10 moles and preferably 1 to 5 moles) of an alkylene oxide (ethylene oxide, propylene oxide) on bisphenol A.

The weight-average molecular weight Mw of the polyester resin A is preferably 10,000 to 100,000 and is more preferably 20,000 to 50,000. The acid value of the polyester resin A is preferably 10.0 to 40.0 mg KOH/g and is more preferably 15.0 to 25.0 mg KOH/g. The hydroxyl value of the polyester resin A is preferably 20.0 to 50.0 mg KOH/g and more preferably 25.0 to 35.0 mg KOH/g.

Examples of the styrene acrylic resin include homopolymers composed of the following polymerizable monomers, copolymers obtained by combining two or more of these, or mixtures thereof.

Styrene-based monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene;
(meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate and 2-benzoyloxyethyl (meth)acrylate, (meth)acrylonitrile, 2-hydroxyethyl (meth)acrylate, (meth)acrylic acid, and maleic acid;
vinyl ether monomers such as vinyl methyl ether and vinyl isobutyl ether;
vinyl ketone monomers such as vinyl methyl ketone, vinyl ethyl ketone, vinyl isopropenyl ketone, and the like; and
polyolefins such as ethylene, propylene, butadiene, and the like.

A polyfunctional polymerizable monomer can be used, if necessary, for the styrene acrylic resin. Examples of the polyfunctional polymerizable monomer include diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl)propane, trimethylolpropane tri(meth)acrylate, tetramethylolmethane tetra(meth)acrylate, divinylbenzene, divinylnaphthalene, divinyl ether, and the like.

Further, in order to control the degree of polymerization, it is also possible to further add a known chain transfer agent and a known polymerization inhibitor.

Examples of the polymerization initiator for obtaining the styrene acrylic resin include organic peroxide-based initiators and azo-based polymerization initiators. Examples of the organic peroxide-based initiator include benzoyl peroxide, lauroyl peroxide, di-α-cumyl peroxide, 2,5-dimethyl-2,5-bis(benzoylperoxy)hexane, bis (4-t-butylcyclohexyl)peroxydicarbonate, 1,1-bis(t-butylperoxy)cyclododecane, t-butylperoxymaleic acid, bis(t-butylperoxy)isophthalate, methyl ethyl ketone peroxide, tert-butylperoxy-2-ethylhexanoate, diisopropylperoxycarbonate, cumene hydroperoxide, 2,4-dichlorobenzoyl peroxide, tert-butyl-peroxypivalate, and the like.

Examples of the azo-based polymerization initiator include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, azobismethylbutyronitrile, 2,2′-azobis-(methyl isobutyrate), and the like.

Further, as the polymerization initiator, a redox-based initiator in which an oxidizing substance and a reducing substance are combined can also be used.

Examples of the oxidizing substance include hydrogen peroxide, an inorganic peroxide of a persulfate (sodium salt, potassium salt and ammonium salt), and an oxidizing metal salt of a tetravalent cerium salt.

Examples of the reducing substance include reducing metal salts (divalent iron salt, monovalent copper salt and trivalent chromium salt), ammonia, lower amines (amines having from 1 to 6 carbon atoms such as methylamine and ethylamine), amine compounds such as hydroxylamine, reducing sulfur compounds such as sodium thiosulfate, sodium hydrosulfite, sodium hydrogen sulfite, sodium sulfite, sodium formaldehyde sulfoxylate, lower alcohols (having 1 to 6 carbon atoms), ascorbic acid or salts thereof and lower aldehydes (having 1 to 6 carbon atoms).

The polymerization initiator is selected with reference to a 10-h half-life temperature, and is used alone or in combination. The amount of the polymerization initiator added varies depending on the desired degree of polymerization but is generally from 0.5 to 20.0 parts by mass with respect to 100.0 parts by mass of the polymerizable monomers.

### Hydrocarbon Wax and Ester Wax

The toner particle comprises wax. The wax comprises a hydrocarbon wax and an ester wax. Known waxes can be used as the hydrocarbon wax and as the ester wax.

The hydrocarbon wax can be specifically exemplified by petroleum waxes as represented by paraffin waxes, microcrystalline waxes, and petrolatum, as well as derivatives of the preceding; hydrocarbon waxes provided by the Fischer-Tropsch method as well as derivatives thereof; and polyolefin waxes as represented by polyethylene, as well as derivatives thereof. The derivatives include oxides, block copolymers with vinyl monomers, and graft modifications.

Other examples include alcohols such as higher fatty alcohols, fatty acids such as stearic acid, palmitic acid, and the like or acid amides, esters and ketones thereof, hardened castor oil and derivatives thereof, vegetable waxes, and animal waxes.

The hydrocarbon wax is preferably a paraffin wax, microcrystalline wax, Fischer-Tropsch wax, or polyolefin (for example, polyethylene), with Fischer-Tropsch waxes being more preferred.

The ester wax can be an ester between a monohydric alcohol and an aliphatic carboxylic acid or an ester between a monobasic carboxylic acid and an aliphatic alcohol, e.g., behenyl behenate, stearyl stearate, and palmityl palmitate; an ester between a dihydric alcohol and an aliphatic acid or an ester between a dibasic carboxylic acid and an aliphatic alcohol, e.g., ethylene glycol distearate, dibehenyl sebacate, and hexanediol dibehenate; and natural ester waxes, e.g., carnauba wax and rice wax. A single one of these may be used or a combination of these may be used.

Preferred among the preceding from the standpoints of crystallinity and compatibility are esters between a monohydric alcohol and an aliphatic carboxylic acid, e.g., behenyl behenate, stearyl stearate, and palmityl palmitate.

The melting point of the ester wax is preferably 55 to 95° C. and more preferably 65 to 85° C. The melting point of the hydrocarbon wax is preferably 55 to 95° C. and more preferably 65 to 85° C.

In addition, other ester waxes may be co-used within a range in which the effects of the present disclosure are not impaired, i.e., esters between a trihydric alcohol and an aliphatic carboxylic acid or esters between a tribasic carboxylic acid and an aliphatic alcohol, e.g., glycerol tribehenate; esters between a tetrahydric alcohol and an aliphatic carboxylic acid or esters between a tetrabasic carboxylic acid and an aliphatic alcohol, e.g., pentaerythritol tetrastearate and pentaerythritol tetrapalmitate; esters between a hexahydric alcohol and an aliphatic carboxylic acid or esters between a hexabasic carboxylic acid and an aliphatic alcohol, e.g., dipentaerythritol hexastearate and dipentaerythritol hexapalmitate; and esters between a polyhydric alcohol and an aliphatic carboxylic acid or esters between a polybasic carboxylic acid and an aliphatic alcohol, e.g., polyglycerol behenate.

### Compound A

In addition, the toner particle preferably comprises a compound A that is at least one compound selected from the group consisting of compounds given by formula (2) and compounds given by formula (3).

R³—O—(A¹-O)ₙ—X . . . (2)

(In formula (2), R³ represents an alkyl group having 8 to 24 carbons; A¹ represents an ethylene group (—CH₂CH₂—) or propylene group (—CH(CH₃)CH₂—); n is an integer from 5 to 60; and X is H, CH₂COOH, CH₂SO₃H, CH₂COONa, or CH₂SO₃Na.)

R⁴-Ph—O—(A²-O)ₘ—X . . . (3)

(In formula (3), R⁴ represents an alkyl group having 8 to 24 carbons; Ph represents a phenylene group; A² represents an ethylene group or propylene group; m represents an integer from 5 to 60; and X is H, CH₂COOH, CH₂SO₃H, CH₂COONa, or CH₂SO₃Na.)

The method for producing these compounds is not particularly limited and any method may be used. For example, production can be carried out by the addition of a prescribed amount of ethylene oxide or propylene oxide, depending on the particular objective, to an aliphatic alcohol. A catalyst may be used in the addition reaction of propylene oxide. An alkali hydroxide, e.g., NaOH, KOH, can be used as this catalyst, as can the catalyst having as its main component magnesium oxide as described in Japanese Patent Application Laid-open No. H08-323200. The former can provide a polyethylene alkyl ether or polypropylene alkyl ether having a relatively broad distribution for the number of moles of addition, while the latter can provide a compound having a relatively narrow distribution for the number of moles of addition.

The compound A may also be used as the surfactant that is provided by way of example in the toner production methods described below.

### Colorant

The toner particle may include a colorant. Known pigments and dyes can be used as the colorant. Pigments are preferable as the colorant from the viewpoint of excellent weather resistance.

Examples of cyan-based colorants include copper phthalocyanine compounds and derivatives thereof, anthraquinone compounds, basic dye lake compounds, and the like.

Specifical examples include C. I. Pigment Blue 1, 7, 15, 15:1, 15:2, 15:3, 15:4, 60, 62, and 66.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds, perylene compounds, and the like.

Specifical examples include C. I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C. I. Pigment Violet 19.

Examples of yellow colorants include condensed azo compounds, isoindolinone compounds, anthraquinone compounds, azo metal complexes, methine compounds, and allylamide compounds.

Specific examples include C. I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of black colorants include those colored black using the above-mentioned yellow colorant, magenta colorant and cyan colorant, and carbon black.

These colorants can be used alone or as a mixture, and they can be used in the form of a solid solution.

It is preferable to use the colorant in an amount of from 1.0 to 20.0 parts by mass with respect to 100.0 parts by mass of the binder resin.

### Charge Control Agent and Charge Control Resin

The toner particle may include a charge control agent or a charge control resin. As the charge control agent, known ones can be used, and in particular, a charge control agent having a high triboelectric charge speed and capable of stably maintaining a constant triboelectric charge quantity is preferable. Further, when the toner particles are produced by the suspension polymerization method, a charge control agent having a low polymerization inhibitory property and providing substantially no solubilized material in an aqueous medium is particularly preferable.

Example of charge control agents that that control the toner to negative-charging include monoazo metal compounds, acetylacetone metal compounds, metal compounds of aromatic hydroxycarboxylic acids, aromatic dicarboxylic acids, hydroxycarboxylic acids and dicarboxylic acids, aromatic hydroxycarboxylic acids, aromatic mono and polycarboxylic acids, and metal salts, anhydrides, and esters thereof, phenol derivatives such as bisphenol, urea derivatives, metal-containing salicylic acid-based compounds, metal-containing naphthoic acid-based compounds, boron compounds, quaternary ammonium salts, calixarene, charge control resins, and the like.

Examples of the charge control resin include polymers or copolymers having a sulfonic acid group, a sulfonic acid base, or a sulfonic acid ester group. Particularly preferable examples of the polymers having a sulfonic acid group, a sulfonic acid base, or a sulfonic acid ester group include polymers including a sulfonic acid group-containing acrylamide-based monomer or a sulfonic acid group-containing methacrylamide-based monomer in a copolymerization ratio of 2% by mass or more, and more preferably 5% by mass or more.

The charge control resin preferably has a glass transition temperature (Tg) of from 35 to 90° C., a peak molecular weight (Mp) of from 10,000 to 30,000, and a weight average molecular weight (Mw) of from 25,000 to 50,000. When such charge control resin is used, favorable triboelectric characteristics can be imparted without affecting the thermal characteristics required for the toner particle. Further, where the charge control resin comprises a sulfonic acid group, for example, the dispersibility of the charge control resin itself in the polymerizable monomer composition and the dispersibility of the colorant and the like are improved, and the tinting strength, transparency and triboelectric charging characteristics can be further improved.

These charge control agents or charge control resins may be added alone or in combination of two or more.

The amount of the charge control agent or charge control resin added is preferably from 0.01 to 20.0 parts by mass, and more preferably from 0.5 to 10.0 parts by mass with respect to 100.0 parts by mass of the binder resin.

### Method for Producing Toner

A method for producing the toner is not particularly limited, and known methods such as a pulverization method, a suspension polymerization method, a dissolution suspension method, an emulsion aggregation method, and a dispersion polymerization method can be used. Here, the toner is preferably produced by an emulsion aggregation method.

The toner production method has the following steps (1) to (3) in the indicated sequence:
(1) a dispersion step of preparing a resin fine particle dispersion that comprises resin, e.g., the binder resin, and a dispersion step of preparing a wax fine particle dispersion that comprises the wax;
(2) an aggregation step of forming aggregates by aggregating the wax-comprising wax fine particles and the resin fine particles comprised in the resin fine particle dispersion; and
(3) a coalescence step of heating the aggregates to cause coalescence.

Preferably this is a toner production method in which a boron compound is added in at least one of the aggregation step and coalescence step.

Also, it is preferable that the following steps (4) to (6) be performed in the following order during or after the coalescence step:
(4) a spherodization step of heating the aggregate by further raising the temperature,
(5) a cooling step of cooling the aggregate at a cooling rate of 0.1° C./see or higher, and
(6) an annealing step of heating and holding the aggregate to a temperature equal to or higher than the crystallization temperature or glass transition temperature of the resin.

The toner is preferably produced by the emulsion aggregation method because the shape of the toner can be controlled and boric acid is likely to be dispersed uniformly near the toner surface. The details of the emulsion aggregation method will be described below.

### Emulsion Aggregation Method

With the emulsion aggregation method, an aqueous dispersion of fine particles composed of constituent materials of toner particles, which are sufficiently small as compared with the target particle diameter, is prepared in advance, these fine particles are aggregated in an aqueous medium until the particle diameter of the toner particles is reached, and the resin is fused by heating or the like to produce toner particles.

That is, in the emulsion aggregation method, toner particles are produced through a dispersion step of producing a fine particle-dispersed solution composed of constituent materials of toner particles, an aggregation step of aggregating the fine particles composed of constituent materials of toner particles to control the particle diameter until the particle diameter of the toner particles is reached, a coalescence step of fusing the resin contained in the obtained aggregated particles, a spheroidization step of melting by further heating or the like to control the surface shape of the toner, a subsequent cooling step, a metal removal step of sorting the obtained toner and removing excess polyvalent metal ions, a filtering/washing step of washing with ion-exchanged water or the like, and a step of removing moisture from the washed toner particles and drying.

### Step of Preparing Resin Fine Particle-Dispersed Solution (Dispersion Step)

The resin fine particle-dispersed solution can be prepared by known methods, but is not limited to these methods. Known methods include, for example, an emulsion polymerization method, a self-emulsification method, a phase inversion emulsification method in which an aqueous medium is added to a resin solution obtained by dissolving in an organic solvent to emulsify the resin, or a forced emulsification method in which a resin is forcibly emulsified by high-temperature treatment in an aqueous medium without using an organic solvent.

Specifically, the resin is dissolved in an organic solvent capable of dissolving the binder resin, and a surfactant or a basic compound is added. At that time, where the resin is a crystalline resin having a melting point, melting may be performed by heating to or above the melting point. Subsequently, an aqueous medium is slowly added while stirring with a homogenizer or the like to precipitate the resin fine particles. Then, the solvent is removed by heating or reducing the pressure to prepare an aqueous dispersion liquid of resin fine particles. As the organic solvent to be used to dissolve the resin, any organic solvent that can dissolve the resin can be used, but from the viewpoint of suppressing the generation of coarse powder, it is preferable to use an organic solvent, such as toluene, that forms a uniform phase with water.

The surfactant used at the time of emulsification is not particularly limited, and examples thereof include anionic surfactants such as sulfuric acid esters and salts, sulfonic acid salts, carboxylic acid salts, phosphoric acid esters, soaps, and the like; cationic surfactants such as amine salts, quaternary ammonium salts, and the like; and nonionic surfactants such as polyethylene glycols, alkylphenol ethylene oxide adducts, polyhydric alcohols, and the like. The surfactants may be used alone or in combination of two or more.

Examples of the basic compound that is used in the dispersion step include inorganic bases such as sodium hydroxide, potassium hydroxide, and the like, and organic bases such as ammonia, triethylamine, trimethylamine, dimethylaminoethanol, diethylaminoethanol, and the like. The basic compounds may be used alone or in combination of two or more.

Further, the 50% particle diameter (D50) of the fine particles of the binder resin in the aqueous dispersion liquid of the resin fine particles which is based on the volume distribution is preferably from 0.05 to 1.0 μm, and more preferably from 0.05 to 0.4 μm. By adjusting the 50% particle diameter (D50) based on the volume distribution to the above range, it becomes easy to obtain toner particles having a volume average particle diameter of from 3 to 10 m which is appropriate for toner particles.

A dynamic light scattering type particle size distribution meter NANOTRACK UPA-EX150 (manufactured by Nikkiso Co., Ltd.) is used to measure the 50% particle diameter (D50) based on the volume distribution.

### Wax Fine Particle Dispersion

The wax fine particle dispersion comprising a wax, e.g., an ester wax or hydrocarbon wax, can be prepared using the known method provided in the following, but there is no limitation to this method.

The wax fine particle dispersion can be produced as follows: the wax is added to a surfactant-comprising aqueous medium; heating is carried out to at least the melting point of the wax and dispersion into particle form is performed using a homogenizer having a strong shear capability (for example, a “ClearMix W-Motion” from M Technique Co., Ltd.) or a pressure ejection-type disperser (for example, a “Gaulin homogenizer” from the Gaulin Co.); and cooling is subsequently carried out to below the melting point of the wax.

With regard to the dispersion particle diameter of the wax fine particle dispersion in the aqueous dispersion, the 50% particle diameter on a volume basis (D50) is preferably 0.03 to 1.0 μm and is more preferably 0.1 to 0.5 μm. In addition, coarse particles 1 μm or larger are preferably not present.

The dispersion particle diameter of the wax fine particle dispersion dispersed in the aqueous medium can be measured using a dynamic light-scattering particle size distribution analyzer (Nanotrac UPA-EX150 from Nikkiso Co., Ltd.).

### Colorant Fine Particle-Dispersed Solution

If necessary, a colorant fine particle-dispersed solution may be used. The colorant fine particle-dispersed solution can be prepared by the following known methods but is not limited to these methods. Thus, the colorant fine particle-dispersed solution can be prepared by mixing a colorant, an aqueous medium, and a dispersing agent with a mixer such as a known stirrer, emulsifier, and disperser. As the dispersing agent to be used here, known substances such as a surfactant and a polymer dispersing agent can be used.

The dispersing agent, whether a surfactant or a polymer dispersing agent, can be removed in the washing step described hereinbelow, but the surfactant is preferable from the viewpoint of washing efficiency.

Examples of the surfactant include anionic surfactants such as sulfuric acid esters and salts, sulfonic acid salts, phosphoric acid esters, soaps, and the like, cationic surfactants such as amine salts and quaternary ammonium salts, and nonionic surfactants such as polyethylene glycols, alkylphenol ethylene oxide adducts, and polyhydric alcohols. Among these, nonionic surfactants or anionic surfactants are preferable. Further, a nonionic surfactant and an anionic surfactant may be used in combination. The surfactants may be used alone or in combination of two or more. The concentration of the surfactant in the aqueous medium is preferably from 0.5 to 5% by mass.

The amount of the colorant fine particles in the colorant fine particle-dispersed solution is not particularly limited but is preferably from 1 to 30% by mass with respect to the total mass of the colorant fine particle-dispersed solution.

Further, as for the dispersed particle diameter of the colorant fine particles in the aqueous dispersion liquid of the colorant, from the viewpoint of the dispersibility of the colorant in the finally obtained toner, the 50% particle diameter (D50) based on the volume distribution is preferably 0.5 μm. Further, for the same reason, it is preferable that the 90% particle diameter (D90) based on the volume distribution be 2 m or less. The dispersed particle diameter of the colorant fine particles dispersed in the aqueous medium is measured by a dynamic light scattering type particle size distribution meter (NANOTRACK UPA-EX150: manufactured by Nikkiso Co., Ltd.).

Examples of mixers such as known stirrers, emulsifiers, and dispersers used to disperse colorants in aqueous media include ultrasonic homogenizers, jet mills, pressure homogenizers, colloid mills, ball mills, sand mills, and paint shakers. These may be used alone or in combination.

### Mixing Step

In the mixing step, a mixture is prepared in which a resin fine particle dispersion and a wax fine particle dispersion, and optionally a colorant fine particle dispersion, are mixed. This can be achieved using a known mixing device such as an homogenizer or mixer.

### Step of Forming Aggregate Particles (Aggregation Step)

In the aggregation step, aggregates with a desired particle diameter are formed by aggregating the fine particles present in the mixture prepared in the mixing step. Here, aggregates, in which the resin fine particles are aggregated with wax fine particles and colorant fine particles, are formed by adding a flocculant with mixing and as necessary applying as appropriate at least one of heating and mechanical force.

Examples of the flocculant include organic flocculants such as quaternary-salt cationic surfactants, polyethyleneimine, and the like; an inorganic metal salts such as sodium sulfate, sodium nitrate, sodium chloride, calcium chloride, calcium nitrate, and the like; inorganic ammonium salts such as ammonium sulfate, ammonium chloride, ammonium nitrate, and the like; and inorganic flocculants such as divalent or higher metal complexes and the like. Further, it is also possible to add an acid so as to lower the pH and cause soft aggregation, and for example, sulfuric acid, nitric acid or the like can be used.

The flocculant may be added in the form of a dry powder or as an aqueous solution obtained by dissolving in an aqueous medium, but it is preferable to add the flocculant in the form of an aqueous solution in order to cause uniform aggregation. Further, it is preferable that the flocculant be added and mixed at a temperature equal to or lower than the glass transition temperature or the melting point of the resin contained in the mixed solution. By mixing under these temperature conditions, aggregation proceeds relatively uniformly. Mixing of the flocculant into the mixed solution can be performed using a known mixing device such as a homogenizer and a mixer. The aggregation step is a step of forming a toner particle-sized aggregate in an aqueous medium. The volume average particle diameter of the aggregates produced in the aggregation step is preferably from 3 to 10 μm. The volume average particle diameter can be measured by a particle size distribution analyzer (Coulter Multisizer III: manufactured by Beckman Coulter, Inc.) by the Coulter method.

### Shell Formation Step, in Which Shell-Bearing Aggregates are Formed by the Further Addition, to the Aggregate-Containing Dispersion, of Resin Fine Particles That Contain a Resin for the Shell, and by the Execution of Aggregation

After bringing about the formation of aggregated particles (core particles) in the aggregation step, a shell formation step is preferably implemented, in which resin fine particles comprising a resin for the shell are further added and aggregation is carried out to form a shell. That is, the toner particle preferably has a binder resin-comprising core particle and a shell on the core particle surface. The same resin as the binder resin may be used for the shell resin, or another resin may be used for the shell resin. The quantity of addition of the shell resin, per 100 parts by mass of the binder resin comprised in the core particle, is preferably from 5 to 100 parts by mass, more preferably from 10 to 50 parts by mass, and still more preferably from 20 to 40 parts by mass.

The shell resin is not particularly limited, and the resins described above for the binder resin can be used. The shell resin preferably comprises a polyester resin. The polyester resin A having an isophthalic acid unit and dodecenylsuccinic acid unit, as has been described in the preceding, may be used for the shell resin.

The incorporation of the compound A in the toner particle is preferably carried out during shell formation by additionally adding, to the aggregate-comprising dispersion, a compound A together with the shell resin-comprising resin fine particles. The addition of a compound A during shell formation can bring about the presence of the compound A in the binder resin and at the toner surface.

In order to facilitate the incorporation of boron in the toner particle, during shell formation preferably a boron compound is added, together with the shell resin-comprising resin fine particles, to the aggregate-comprising dispersion in the shell formation step.

The boron compound may be boric acid or a compound that can be converted to boric acid by, for example, pH adjustment during toner production. Examples are at least one selection from the group consisting of, for example, boric acid, borax, organoboric acids, borate salts, borate esters, and so forth. For example, a boron compound may be added and control may be exercised such that boric acid is present in the aggregate. Preferably the pH is controlled to acidic conditions in the aggregation step and the shell formation step is then executed

A uniform formation of aggregation of the shell resin to the core particle is facilitated by the presence of boric acid in the shell formation step, and as a consequence a small wax domain area in the vicinity of the surface can be brought about.

Boric acid may be present in the aggregate in an unsubstituted state. The boron compound is preferably at least one selected from the group consisting of boric acid and borax. When the toner is produced in an aqueous medium, it is preferable to add a boric acid salt as a boron compound from the viewpoint of reactivity and production stability. Specifically, the boron compound more preferably comprises at least one selected from the group consisting of sodium tetraborate, borax, ammonium borate, and the like, and more preferably borax.

Borax is represented by the decahydrate of sodium tetraborate Na₂B₄O₇ and changes to boric acid in an acidic aqueous solution. Therefore, borax is preferably used when using in an acidic environment in an aqueous medium. As a method of addition, either a dry powder or an aqueous solution obtained by dissolving in an aqueous medium may be added, but in order to induce uniform aggregation, it is preferable to add in the form of an aqueous solution. The concentration of the aqueous solution may be changed, as appropriate, according to the concentration in the toner, and is, for example, from 1 to 20% by mass. In order to change to boric acid, it is preferable to set the pH to acidic conditions before, during or after the addition. For example, control may be performed to 1.5 to 5.0, and preferably to 2.0 to 4.0.

### Step of Obtaining a Toner Particle-Containing Dispersion (Coalescence Step)

In the coalescence step, the aggregation in the dispersion liquid comprising the aggregates obtained in the aggregation step is first stopped under the same stirring as in the aggregation step. The aggregation is stopped by adding an aggregation terminator such as a base or a chelate compound capable of adjusting pH, or an inorganic salt compound such as sodium chloride or the like.

After the state of dispersion of the aggregated particles in the dispersion has been stabilized by the action of the aggregation terminator, heating is carried out to at least the glass transition temperature or melting point of the resin, e.g., the binder resin, to effect coalescence of the aggregated particle and adjust to a desired particle diameter. The 50% particle diameter on a volume basis (D50) of the toner particle is preferably 3 to 10 μm.

### Step of Obtaining a Desired Surface Profile for the Toner (Spheroidizing Step)

During the coalescence step or after the coalescence step, a spheroidizing step is preferably implemented in which the temperature is raised further and is maintained until the toner particle assumes a desired circularity or surface profile. The specific temperature of the spheroidizing step is, for example, at least 85° C. and is preferably at least 90° C. and preferably not more than 95° C. The heating time in the spheroidizing step can be exemplified by heating times of, for example, at least one hour, or at least two hours, or at least three hours. The upper limit is, for example, less than or equal to five hours. The formation in the toner particle of hydrogen bonds originating with boric acid is facilitated by this step.

### Cooling Step

After the spheroidizing step, a cooling step is preferably implemented, in which the temperature of the obtained toner particle-comprising dispersion is cooled, while controlling the cooling rate, to a temperature lower than the crystallization temperature or glass transition temperature of the resin, e.g., the binder resin, and the crystalline component of the wax, e.g., the hydrocarbon wax and ester wax. The execution of the cooling step enables an inhibition of changes in the domain shape accompanying crystallization of the crystalline component of the wax. Control of the proportion of the domain area of the crystalline component due to the wax in the vicinity of the toner particle surface is facilitated as a result.

The specific cooling rate is at least 0.1° C./second and is preferably at least 0.5° C./second, more preferably at least 2° C./second, and still more preferably at least 4° C./second. The upper limit is, for example, 20° C./second or less, or 15° C./second or less.

### Annealing Step

After the cooling step, an annealing step may be carried out of heating to and maintaining at a temperature that is at least the crystallization temperature or at least the glass transition temperature of the resin and that is not greater than the crystallization temperature of the wax. Through the execution of the annealing step, the crystalline component that has compatibilized to the resin of the toner particle is crystallized and changes in the domain shape can be further suppressed.

### Post-Treatment Step

In the toner production method, a post-treatment step such as a washing step, a solid-liquid separation step, and a drying step may be further performed, and by performing the post-treatment step, toner particles in a dried state can be obtained.

### External Addition Step

The obtained toner particle may be used as such as a toner; however, in an external addition step, an external additive, e.g., silica fine particles, may be externally added to the toner particle yielded by the drying step.

With regard to the external addition conditions, the state of attachment of the external additive and the state of the coating of the toner particle by the external additive can be freely controlled using the external addition time and the rotation rate rpm of the stirring blade in the external addition device.

Thus, in order to achieve a firm attachment, it is effective to raise the rotational speed and lengthen the external addition time, and in the particular the fixing strength can be enhanced by increasing the rotational speed. In addition, since external additive particles with their small particle diameters form aggregates, the coating treatment of the toner particle with the external additive is carried out while executing a deagglomeration treatment by controlling the external addition conditions. The deagglomeration performance can be raised by raising the rotational speed and lengthening the external addition time; however, in order to further advance deagglomeration while restraining the fixing strength, it is effective to restrain the rotational speed while lengthening the external addition time.

The weight-average particle diameter (D4) of the toner is preferably 4.0 to 12.0 μm and is more preferably 4.0 to 8.0 μm.

### Methods for Measuring Each of the Properties

Next, methods for measuring each physical property according to the present disclosure will be described.

### Measurement of Weight Average Particle Diameter (D4) and Number Average Particle Diameter (D1) of Toner or Toner Particles

The weight-average particle diameter (D4) and the number-average particle diameter (D1) of the toner or toner particles are calculated in the manner described below. A precision particle size distribution measuring apparatus based on a pore electric resistance method with a 100 μm aperture tube (a Coulter Counter Multisizer 3 (registered trademark) produced by Beckman Coulter, Inc.) and dedicated software for the measurement apparatus (Beckman Coulter Multisizer 3 Version 3.51 produced by Beckman Coulter, Inc.) for setting measurement conditions and analysis of measured data are used for measurement. The measurements are carried out using 25,000 effective measurement channels, and then measurement data is analyzed and calculated.

A solution obtained by dissolving special grade sodium chloride in ion exchanged water at a concentration of approximately 1 mass %, such as “ISOTON II” (produced by Beckman Coulter), can be used as an aqueous electrolyte solution used in the measurements.

The dedicated software was set up in the following way before carrying out measurements and analysis. On the “Standard Operating Method (SOM) alteration” screen in the dedicated software, the total count number in control mode is set to 50,000 particles, the number of measurements is set to 1, and the Kd value is set to the value obtained by using “standard particle 10.0 m” (Beckman Coulter). By pressing the “Threshold value/noise level measurement button”, threshold values and noise levels are automatically set. In addition, the current is set to 1600 μA, the gain is set to 2, the electrolyte solution is set to ISOTON II, and the “Flush aperture tube after measurement” option is checked. On the “Conversion settings from pulse to particle diameter” screen in the dedicated software, the bin interval is set to logarithmic particle diameter, the particle diameter bin is set to 256 particle diameter bin, and the particle diameter range is set to from 2 to 60 μm.

The specific measurement method is as follows.
1. 200 mL of the aqueous electrolyte solution is placed in a dedicated Multisizer 3 250 mL glass round bottomed beaker, the beaker is set on a sample stand, and a stirring rod is rotated anticlockwise at a rate of 24 rotations/second. By carrying out the “Aperture tube flush” function of the dedicated software, dirt and bubbles in the aperture tube are removed.
2. Approximately 30 mL of the aqueous electrolyte solution is placed in a 100 mL glass flat bottomed beaker. 0.3 mL of a diluted liquid, which is obtained by diluting “Contaminon N” (a 10 mass % aqueous solution of a neutral detergent for cleaning precision measurement equipment, which has a pH of 7 and comprises a non-ionic surfactant, an anionic surfactant and an organic builder, available from Wako Pure Chemical Industries, Ltd.) approximately 3-fold in terms of mass with ion exchanged water, is added to the beaker as a dispersant.
3. An ultrasonic wave disperser (Ultrasonic Dispersion System Tetra 150 produced by Nikkaki Bios Co., Ltd.) having an electrical output of 120 W, in which two oscillators having an oscillation frequency of 50 kHz are housed so that their phases are staggered by 180° is prepared. A predetermined amount of ion exchanged water is placed in a water bath in the ultrasonic dispersion system, and 2 mL of Contaminon N is added to this water bath.
4. The beaker mentioned in step (2) above is placed in a beaker-fixing hole in the ultrasonic wave disperser, and the ultrasonic wave disperser is activated. The height of the beaker is adjusted so that the resonant state of the liquid surface of the aqueous electrolyte solution in the beaker is at a maximum.
5. While the aqueous electrolyte solution in the beaker mentioned in section (4) above is being irradiated with ultrasonic waves, 10 mg of toner is added a little at a time to the aqueous electrolyte solution and dispersed therein. The ultrasonic wave dispersion treatment is continued for a further 60 seconds. When carrying out the ultrasonic wave dispersion, the temperature of the water bath is adjusted as appropriate to a temperature of from 10° C. to 40° C.
6. The aqueous electrolyte solution mentioned in section (5) above, in which the toner is dispersed, is added dropwise by means of a pipette to the round bottomed beaker mentioned in section (1) above, which is disposed on the sample stand, and the measurement concentration is adjusted to 5%. Measurements are carried out until the number of particles measured reaches 50,000.
7. The weight-average particle diameter (D4) and the number-average particle diameter (D1) are calculated by analyzing measurement data using the accompanying dedicated software. The “AVERAGE DIAMETER” on the “ANALYSIS/VOLUME STATISTICAL VALUE (ARITHMETIC MEAN)” screen when the special software is set to graph/volume % is the weight average particle diameter (D4). The “AVERAGE DIAMETER” on the “ANALYSIS/NUMBER STATISTICAL VALUE (ARITHMETIC MEAN)” screen when the special software is set to graph/number % is the number average particle diameter (D1).

### Measurement of the Acid Value

The acid value is the number of milligrams of potassium hydroxide required to neutralize the acid present in 1 g of a sample. The acid value of the resin is measured in accordance with JIS K 0070-1992, and specifically is measured using the following procedure.

(1) Reagent preparation

1.0 g of phenolphthalein is dissolved in 90 mL of ethyl alcohol (95 vol %), and this is brought to 100 mL by the addition of deionized water to provide a phenolphthalein solution.

7 g of special-grade potassium hydroxide is dissolved in 5 mL of water and this is brought to 1 L by the addition of ethyl alcohol (95 vol %). This is introduced into an alkali-resistant container avoiding contact with, for example, carbon dioxide, and is allowed to stand for 3 days, after which time filtration is carried out to obtain a potassium hydroxide solution. The obtained potassium hydroxide solution is stored in an alkali-resistant container. The factor for this potassium hydroxide solution is determined from the amount of the potassium hydroxide solution required for neutralization when 25 mL of 0.1 mol/L hydrochloric acid is introduced into an Erlenmeyer flask, several drops of the phenolphthalein solution are added, and titration is performed using the potassium hydroxide solution. The 0.1 mol/L hydrochloric acid used is prepared in accordance with JIS K 8001-1998.

### (2) Procedure

(A) Main test

A 2.0 g sample of the pulverized resin is exactly weighed into a 200-mL Erlenmeyer flask and 100 mL of a toluene/ethanol (2:1) mixed solution is added and dissolution is carried out over 5 hours. Several drops of the phenolphthalein solution are added as indicator and titration is performed using the potassium hydroxide solution. The titration endpoint is taken to be the persistence of the faint pink color of the indicator for 30 seconds.

(B) Blank test

The same titration as in the above procedure is run, but without using the sample (that is, with only the toluene/ethanol (2:1) mixed solution).
(3) The acid value is calculated by substituting the obtained results into the following formula.

$$A = [ ( C - B ) \times f \times 5.61 ] / S$$

Here, A: acid value (mg KOH/g), B: amount (mL) of addition of the potassium hydroxide solution in the blank test, C: amount (mL) of addition of the potassium hydroxide solution in the main test, f: factor for the potassium hydroxide solution, S: mass (g) of sample.

### Method for Measuring the Hydroxyl Value

The hydroxyl value is the number of milligrams of potassium hydroxide required to neutralize the acetic acid bonded with the hydroxyl group when 1 g of the sample is acetylated. The hydroxyl value of the binder resin is measured based on JIS K 0070-1992 and in specific terms is measured according to the following procedure.

(1) Reagent preparation

25 g of special-grade acetic anhydride is introduced into a 100-mL volumetric flask; the total volume is brought to 100 mL by the addition of pyridine; and thorough shaking then provides the acetylation reagent. The obtained acetylation reagent is stored in a brown bottle isolated from contact with, e.g., humidity, carbon dioxide, and so forth. A phenolphthalein solution is obtained by dissolving 1.0 g of phenolphthalein in 90 mL of ethyl alcohol (95 vol %) and bringing to 100 mL by the addition of deionized water.

35 g of special-grade potassium hydroxide is dissolved in 20 mL of water and this is brought to 1 L by the addition of ethyl alcohol (95 vol %). After standing for 3 days in an alkali-resistant container isolated from contact with, e.g., carbon dioxide, filtration is performed to obtain a potassium hydroxide solution. The obtained potassium hydroxide solution is stored in an alkali-resistant container. The factor for this potassium hydroxide solution is determined as follows: 25 mL of 0.5 mol/L hydrochloric acid is taken to an Erlenmeyer flask; several drops of the above-described phenolphthalein solution are added; titration is performed with the potassium hydroxide solution; and the factor is determined from the amount of the potassium hydroxide solution required for neutralization. The 0.5 mol/L hydrochloric acid used is prepared in accordance with JIS K 8001-1998.

### (2) Procedure

(A) Main test

A 1.0 g sample is exactly weighed into a 200-mL roundbottom flask and exactly 5.0 mL of the above-described acetylation reagent is added from a whole pipette. When the sample is difficult to dissolve in the acetylation reagent, dissolution is carried out by the addition of a small amount of special-grade toluene.

A small funnel is mounted in the mouth of the flask and heating is then carried out by immersing 1 cm of the bottom of the flask in a glycerol bath at approximately 97° C. In order at this point to prevent the temperature at the neck of the flask from rising due to the heat from the bath, heavy paper in which a round hole has been made is preferably mounted at the base of the neck of the flask.

After 1 hour, the flask is taken off the glycerol bath and allowed to cool. After cooling, the acetic anhydride is hydrolyzed by adding 1 mL of water from the funnel and shaking. In order to accomplish complete hydrolysis, the flask is again heated for 10 minutes on the glycerol bath. After cooling, the funnel and flask walls are washed with 5 mL of ethyl alcohol.

Several drops of the above-described phenolphthalein solution are added as the indicator and titration is performed using the above-described potassium hydroxide solution. The endpoint for the titration is taken to be the point at which the pale pink color of the indicator persists for 30 seconds.

(B) Blank test

Titration is performed using the same procedure as described above, but without using the sample.
(3) The hydroxyl value is calculated by substituting the obtained results into the following formula.

$$A = [ \{ ( B - C ) \times 28.05 \times f \} / S ] + D$$

Here, A: hydroxyl value (mg KOH/g); B: amount of addition (mL) of the potassium hydroxide solution in the blank test; C: amount of addition (mL) of the potassium hydroxide solution in the main test; f: factor for the potassium hydroxide solution; S: mass (g) of the sample; and D: acid value (mg KOH/g) of the sample.

### Method for Measuring the Isophthalic Acid Unit Content and Dodecenylsuccinic Acid Unit Content in the Polyester Resin A, Toner, or Toner Particle

Pyrolysis gas chromatography-mass spectroscopy (below, pyrolysis GC/MS) and NMR are used for the isophthalic acid unit content and dodecenylsuccinic acid unit content comprised in the polyester resin A and toner.

The following procedure is specifically carried out.
(1) 50 mg of the polyester resin A, toner, or toner particles are exactly weighed into an 8-mL glass sample vial; 1 mL of deuterated chloroform is added and the cap is then applied; and dispersion and dissolution are carried out for 1 hour using an ultrasonic disperser. Filtration is then carried out using a 0.4 μm-diameter membrane filter and the filtrate is recovered. At this point, the deuterated chloroform-insoluble matter remains on the membrane filter.
(2) ¹H-NMR measurement and ¹³C-NMR measurement are carried out on the filtrate; the components comprised in the toner are assigned based on the spectra; and the contents of the isophthalic acid unit and dodecenylsuccinic acid unit present in the toner are calculated.
(3) When identification is inadequate, further analysis is carried out using pyrolysis GC/MS, and as necessary a derivatization treatment, e.g., methylation, is performed, and composition analysis is carried out.
(4-1) With regard to the isophthalic acid unit content and dodecenylsuccinic acid unit content in the polyester resin A, the contents are calculated on a mass basis from the results of the analysis of the identified components. A known procedure can be used for separation of the polyester resin from the toner.
(4-2) With regard to the isophthalic acid unit content and dodecenylsuccinic acid unit content with reference to the mass of the binder resin, the amount of binder resin in the toner is calculated in accordance with “Method for measuring the hydrocarbon wax content W1 and the ester wax content W2 present in the toner”, see below, and these values can be used to calculate the proportion of monomer unit corresponding to dodecenylsuccinic acid with reference to the mass of the binder resin.

### NMR Measurement Conditions

Bruker AVANCE 500 from Bruker BioSpin
measurement nuclei: ¹H, ¹³C
measurement frequency: 500.1 MHz
number of scans: 16 times, 2048 times
measurement temperature: room temperature

### Pyrolysis GC/MS Measurement Conditions

pyrolysis instrument: TPS-700 from Japan Analytical Industry Co., Ltd.
pyrolysis temperature: suitable value from 400° C. to 600° C.
GC/MS instrument: ISQ from Thermo Fisher Scientific Inc.
column: “HP5-MS” (Agilent/19091S-433), length of 30 μm, internal diameter of 0.25 mm, film thickness of 0.25 μm

### GC/MS Conditions

Injection Port Conditions:
   inlet temp: 250° C.
   split flow: 50 mL/min
GC ramp conditions: 40° C. (5 min)→10° C./min (300° C.)→300° C. (20 min)

### Measurement of the Molecular Weight of the Polyester Resin

The molecular weight (weight-average molecular weight Mw) of the polyester resin is measured using gel permeation chromatography (GPC) as follows.

First, the polyester resin is dissolved in tetrahydrofuran (THF) at room temperature for 24 hours. The obtained solution is filtered using a “Sample Pretreatment Cartridge” (Tosoh Corporation) solvent-resistant membrane filter having a pore diameter of 0.2 μm to obtain a sample solution. The sample solution is adjusted to a concentration of THF-soluble matter of 0.8 mass %. Measurement is carried out under the following conditions using this sample solution.
instrument: HLC8120 GPC (detector: RI) (Tosoh Corporation)
column: 2-column train of Shodex LF-404, LF-404 (Showa Denko Kabushiki Kaisha)
eluent: tetrahydrofuran (THF)
flow rate: 1.0 mL/min
oven temperature: 40.0° C.
sample injection amount: 0.10 mL

A molecular weight calibration curve constructed using polystyrene resin standards (for example, product name “TSK Standard Polystyrene F-850, F-450, F-288, F-128, F-80, F-40, F-20, F-10, F-4, F-2, F-1, A-5000, A-2500, A-1000, A-500”, Tosoh Corporation) is used to determine the molecular weight of the sample.

### Identification of Molecular Structure of the Hydrocarbon Wax and Ester Wax Contained in the Toner

The hydrocarbon wax and ester wax are first isolated from the toner using the following separation procedure. The toner is dispersed in ethanol, which is a poor solvent for the toner, and the temperature is raised to a temperature above the melting point of the wax. Pressure may be applied at this time as necessary. Through this procedure, the wax residing above its melting point is melted·extracted into the ethanol. When heat and pressure have been applied, the wax can be separated from the toner by carrying out solid/liquid separation while keeping the pressurization. The wax is then obtained by drying·solidification of the extraction solution. The hydrocarbon wax and ester wax can be isolated by partitioning the obtained wax by molecular weight.

Identification of the molecular structures of the isolated hydrocarbon wax and ester wax is then carried out. Pyrolysis gas chromatography-mass spectroscopy (below, pyrolysis GC/MS) and NMR are used for molecular structure identification.

The following procedure is specifically carried out.
(1) 50 mg of the toner is exactly weighed into an 8-mL glass sample vial; 1 mL of deuterated chloroform is added and the cap is then applied; and dispersion and dissolution are carried out for 1 hour using an ultrasonic disperser. Filtration is then carried out using a 0.4 μm-diameter membrane filter and the filtrate is recovered. At this point, the deuterated chloroform-insoluble matter remains on the membrane filter.
(2) ¹H-NMR measurement is run on the filtrate and spectrum assignment is carried out for each of the constituent monomers of the hydrocarbon wax and ester wax.
(3) Analysis is carried out using pyrolysis GC/MS. As necessary a derivatization treatment, e.g., methylation, is performed, and the molecular weights of the hydrocarbon wax and ester wax are calculated.

### NMR Measurement Conditions

Bruker AVANCE 500 from Bruker BioSpin
measurement nuclei: ¹H
measurement frequency: 500.1 MHz
number of scans: 16 times
measurement temperature: room temperature

### Pyrolysis GC/MS Measurement Conditions

pyrolysis instrument: TPS-700 from Japan Analytical Industry Co., Ltd.
pyrolysis temperature: suitable value from 400° C. to 600° C.
GC/MS instrument: ISQ from Thermo Fisher Scientific Inc.
column: “HP5-MS” (Agilent/19091S-433), length of 30 μm, internal diameter of 0.25 mm, film thickness of 0.25 μm
   GC/MS conditions
Injection port conditions:
   inlet temp: 250° C.
   split flow: 50 mL/min
GC ramp conditions: 40° C. (5 min)→10° C./min (300° C.)→300° C. (20 min)

### Method for Measuring the Hydrocarbon Wax Content W1 and the Ester Wax Content W2 Present in the Toner

The hydrocarbon wax content W1 and ester wax content W2, per 100 parts by mass of the binder resin in the toner, are calculated using the following procedure. The mass X1 of the tetrahydrofuran (THF)-soluble matter, the mass X2 of the tetrahydrofuran (THF)-insoluble matter, and the incineration ash content X3 in the toner are first determined. Calculation can next be performed by determining the hydrocarbon wax proportion w1 and ester wax content w2 in the toner.

Specifically, 1.5 g of toner is exactly weighed out and is introduced into an exactly pre-weighed thimble filter (product name: No. 86R, size 28×100 mm, Advantec Toyo) and this is installed in a Soxhlet extractor. Extraction is performed for 20 hours using 200 mL of tetrahydrofuran (THF) as solvent; this extraction is performed at a reflux rate that provides an extraction cycle for the solvent of once in five minutes. After the completion of extraction, the thimble filter is removed and is air dried; vacuum drying is then carried out for 8 hours at 40° C.; the mass of the extraction residue-containing thimble filter is weighed; and subtraction of the mass of the thimble filter then gives the mass of the extraction residue, which is designated the mass X2 (g) of the tetrahydrofuran (THF)-insoluble matter in the toner. The mass X1 (g) of the tetrahydrofuran (THF)-soluble matter in the toner is determined using the following formula (A).

X1=1.5−X2 . . . (A)

The content X3 (g) of the component other than the resin component is next determined using the following procedure. 1.5 g of the toner is exactly weighed into a pre-weighed 30-mL magnetic crucible. The magnetic crucible is placed in an electric oven and is heated for three hours at 900° C. and is allowed to cool in the electric oven and allowed to cool for at least one hour in a desiccator at normal temperature; the mass of the crucible containing the incineration ash content is weighed and the incineration ash content X3 (g) is calculated by subtracting the mass of the crucible.

The extraction solution yielded by the preceding procedure is filtered using a “Sample Pretreatment Cartridge” (Tosoh Corporation) solvent-resistant membrane filter having a pore diameter of 0.2 μm to obtain a sample solution. Measurement is carried out under the following conditions using this sample solution.
instrument: HLC8320 GPC (detector: RI) (Tosoh Corporation)
column: 2-column train of Shodex LF-404, LF-404 (Showa Denko Kabushiki Kaisha)
eluent: tetrahydrofuran (THF)
flow rate: 1.0 mL/min
oven temperature: 40.0° C.
sample injection amount: 0.10 mL

The following are measured: the total area S of the molecular weight distribution of the obtained tetrahydrofuran (THF)-soluble matter in the toner, and the peak area P1 originating with the hydrocarbon wax and area P2 originating with the ester wax, that have a molecular weight corresponding to the waxes identified by the previously described procedure. The amount w1 of hydrocarbon wax in the toner can be determined using the following formula (B), and the amount w2 of ester wax in the toner can be determined using the following formula (C).

$$\begin{matrix}w 1 = ( X 1 \times P 1 / S ) \\ = \{ ( 1. 5 - X 2 ) \times P 1 / S \}\end{matrix} \qquad ( B )$$

$$\begin{matrix}w 2 = ( X 1 \times P 2 / S ) \\ = \{ ( 1. 5 - X 2 ) \times P 2 / S \}\end{matrix} \qquad ( C )$$

In addition, obtaining, by the aforementioned GPC, the total area S of the molecular weight distribution of the tetrahydrofuran (THF)-soluble matter in the toner and the area Pw originating with the total wax, the amount R of the binder resin in the toner can be determined using the following formula (R).

$$R = \{ X 1 + ( X 2 - X 3 ) \} - ( X 1 \times {P}_{w} / S ) \qquad ( R )$$

The hydrocarbon wax content W1 and ester wax content W2, per 100 parts by mass of the binder resin, can be determined from the obtained amount w1 of hydrocarbon wax, ester wax content w2, and binder resin amount R.

### Measurement of the Amount of Extraction of Compound A That is Extracted by Ethanol

The amount of extraction of compound A that is extracted by ethanol from the toner is determined proceeding as follows using ¹H-NMR (nuclear magnetic resonance) measurement.

50 mL ethanol and 5 g of exactly weighed toner are thoroughly mixed in a sample bottle, followed by exposure for 30 minutes to ultrasound using a tabletop ultrasound cleaner (product name “B2510JMTH”, Branson Ultrasonics Corporation) having an oscillation frequency of 42 kHz and an electrical output of 125 W. This is followed by filtration using a “Sample Pretreatment Cartridge” (Tosoh Corporation) solvent-resistant membrane filter having a pore diameter of 0.2 μm. The ethanol is removed from the filtrate using an evaporator, followed by dissolution with 10 mg trimethylsilane (TMS)-containing deuterochloroform (1% TMS), and the structure of the compound A is identified by analysis by ¹H-NMR.

Separately, ¹H-NMR measurement of the identified compound A is carried out and the amount of extraction (ppm) of the compound A extracted from the toner is calculated using a calibration curve of TMS intensity standards. The calibration curve is constructed from the TMS intensity and the peak intensity ratio originating with the hydrogen of the ethylene oxide group in the vicinity of 3.0 to 5.0 ppm. The measurement instrument and measurement conditions are as follows.
NMR Measurement Conditions
Bruker AVANCE 500 from Bruker BioSpin
measurement nuclei: ¹H
measurement frequency: 500.1 MHz
number of scans: 1024 times
measurement temperature: room temperature
   Calculation of as, the Average Proportion for the Area Taken Up by Domains Due to the Wax in the Surface Layer Region to a Depth of 200 nm from the Surface of the Toner Particle

The state of distribution of the crystallized wax in the toner is evaluated by observing a cross section of a toner particle using a transmission electron microscope and calculating As from the cross-sectional area of the domains formed by the crystallized wax; the evaluation is carried out using the average value of 100 randomly selected toner particles.

Specifically, the toner is embedded using a visible light-curable embedding resin (D-800, Nisshin EM Co., Ltd.); sectioning at a thickness of 60 nm is performed using an ultrasound ultramicrotome (EM5, Leica); and Ru staining is performed using a vacuum staining instrument (Filgen, Inc). This is followed by observation using a transmission electron microscope (H7500, Hitachi) at an acceleration voltage of 120 kV. Imaging is carried out selecting 100 toner particles that are within ±2.0 μm of the weight-average particle diameter. The resin regions and the domains of the crystallized wax component are differentiated using image processing software (Photoshop (registered trademark) 5.0, Adobe) on the obtained image. Specifically, the domains of the crystallized wax component can be distinguished proceeding as follows. Using the image processing software, the captured TEM image is binarized with the brightness (255 gradations) threshold value set to 160. When this is done, the crystallized wax component of the toner and the D800 light-curable resin form bright areas, and outside the crystalline resin component of the toner forms dark areas. The contour of the toner can be delineated by the contrast between the toner and light-curable resin.

Residual masking is performed of the surface layer region in the toner particle cross section to a depth of 200 nm from the toner particle surface (contour of the cross section). Specifically, a line is drawn from the centroid of the toner particle cross section to a point on the contour of the toner particle cross section. A position 200 nm from the contour in the direction of the centroid is identified on the line. This operation is then performed for one circumference of the contour of the toner particle cross section, thus specifying the surface layer region up to 200 nm from the contour of the toner particle cross section. The percentage of the area occupied by domains of the crystallized wax component in the area of the obtained surface layer region is calculated and designated as As.

### Method for Quantitating the Boron Atom With Reference to the Mass of the Toner Particle

The content of the boron (B) atom with reference to the mass of the toner particle is quantitated using an inductively coupled plasma-mass spectrometer (ICP-MS). Acid digestion as described below is carried out on the toner particle as a pretreatment, and, after obtaining the ICP-MS measurement solution, the boron atom in the toner particle can be quantitated by carrying out an ICP-MS measurement.

### Pretreatment

device: microwave pretreatment device (ETHOS SEL) from Milestone General K. K. sample amount: 50 mg

5.00 mL of 68% nitric acid (for atomic absorption spectroscopy, Kanto Chemical Co., Inc.) was added to 50 mg of the toner particle and the indicated device was used to perform an acid digestion. A desired ICP-MS measurement solution was obtained by executing the acid digestion in two stages. The acid digestion conditions are as follows.

### First Stage of Acid Digestion

The heating temperatures and retention times during acid digestion were executed according to the following schedule.

Normal temperature, 60° C. (2 minutes), 40° C. (2 minutes), 160° C. (6 minutes), 220° C. (8 minutes), 180° C. (1 minute), 220° C. (4 minutes), 220° C. (holding for 30 minutes), cool to room temperature (25° C.).

### Second Stage of Acid Digestion

The heating temperatures and retention times during acid digestion were executed according to the following schedule.

Supplemental addition of 3 mL nitric acid, normal temperature, 180° C. (5 minutes), 150° C. (1 minute), 220° C. (2 minutes), 220° C. (holding for 27 minutes), cool to room temperature (25° C.).

The thusly obtained solution was brought to 50 mL with ultrapure water. Additional 100× dilution with ultrapure water gave the ICP-MS measurement solution.

### Quantitation of the Boron Atom in the Toner Particle Using an Inductively Coupled Plasma-Mass Spectrometer

The thusly obtained ICP-MS measurement solution was used to quantitate the boron atom content using the following instrument and conditions.
instrument: ICP-MS NexION 350D inductively coupled plasma-mass spectrometer from PerkinElmer Inc.
Measurement Mode: Standard Mode, Calibration Curve Method
Element to be Measured: Boron
Mass Number: 11.0093
Scan Mode: Peak Hopping
residence time: 50 ms
detector: dual
peristaltic pump speed: 20.0 rpm

The boron atom content with reference to the toner particle mass was thereby quantitated.

Method for Obtaining Toner Particles by Removing External Additive from Toner

A total of 160 g of sucrose (manufactured by Kishida Chemical Co., Ltd.) is added to 100 mL of ion-exchanged water and dissolved in a water bath to prepare a sucrose concentrate. A total of 31 g of the sucrose concentrate and 6 mL of Contaminone N (10% by mass aqueous solution of a neutral detergent for cleaning precision measuring instruments that is composed of a nonionic surfactant, an anionic surfactant, and an organic builder and has pH 7, manufactured by Wako Pure Chemical Industries, Ltd.) are placed in a centrifuge tube (50 ml capacity) to prepare a dispersion liquid. To this dispersion liquid, 1.0 g of toner is added, and toner lumps are loosened with a spatula or the like. A centrifuge tube is shaken with a shaker (AS-1N, sold by AS ONE Corporation) at 300 spm (strokes per min) for 20 min. After shaking, the solution is transferred to a glass tube (50 mL) for a swing rotor, and separation is performed by a centrifuge (H-9R, manufactured by Kokusan Co., Ltd.) at 3500 rpm for 30 min.

By this operation, the toner particles and the external additive are separated. Sufficient separation of the toner particles and the aqueous solution is visually confirmed, and the toner particles separated in the uppermost layer are collected with a spatula or the like. The collected toner particles are filtered with a vacuum filter and then dried with a dryer for 1 h or more to obtain a sample for measurement. This operation is performed multiple times to secure the required amount.

### EXAMPLES

The present disclosure is more particularly described below using examples and comparative examples. Insofar as the essential features of the present disclosure are not exceeded, the present disclosure is in no way limited by the following examples. In the following text of the examples, “parts” is on a mass basis unless specifically indicated otherwise.

### Synthesis of Polyester Resin 1

| | |
|---|---|
| 2 mol propylene oxide adduct on bisphenol A | 500 parts by mass |
| 2 mol ethylene oxide adduct on bisphenol A | 460 parts by mass |
| isophthalic acid | 330 parts by mass |
| dodecenylsuccinic acid | 160 parts by mass |

The above monomers were put into a flask equipped with a stirrer, a nitrogen introduction tube, a temperature sensor, and a rectification column, the temperature was raised to 195° C. over 1 h, and it was confirmed that the inside of the reaction system was uniformly stirred. A total of 1.2 parts by mass of tin distearate was added to 100 parts of these monomers. Further, the temperature was raised from 195° C. to 240° C. over 5 h while distilling off the generated water, and a dehydration condensation reaction was carried out at 240° C. for another 2 h. Then, the temperature was lowered to 190° C., 40 parts by mass of trimellitic anhydride was gradually added, and the reaction was continued at 190° C. for 1 h.

This resulted in the production of a polyester resin 1 having an acid value of 21.8 mg KOH/g, a hydroxyl value of 28.7 mg KOH/g, and a weight-average molecular weight of 32,000. Polyester resin 1 is reported in Table 1-1 and Table 1-2.

### Synthesis of Polyester Resins 2 to 18

Polyester resins 2 to 18 were obtained proceeding as in the polyester resin 1 synthesis example, but changing the polyester raw materials used in the polyester resin 1 synthesis example as shown in Table 1.

Polyester resins 2 to 18 are shown in Table 1-1 and Table 1-2.

TABLE 1-1

| | amount of starting material charged (parts by mass) | | | | | | | |
|---|---|---|---|---|---|---|---|---|
| | | | | acid monomer | | | | |
| | alcohol monomer | | | | dodecenyl | | | |
| | 1,2-ethylene | | | isophthalic | succinic | terephthalic | sebacic | trimellitic |
| | glycol | BPA-2PO | BPA-2EO | acid | acid | acid | acid | anhydride |
| polyester resin 1 | — | 500 | 460 | 330 | 160 | — | — | 40 |
| polyester resin 2 | — | 500 | 460 | 330 | 70 | — | 90 | 30 |
| polyester resin 3 | — | 500 | 460 | 330 | 250 | — | — | 20 |
| polyester resin 4 | — | 500 | 460 | 230 | 50 | 100 | 110 | 40 |
| polyester resin 5 | — | 500 | 460 | 250 | 160 | 80 | — | 40 |
| polyester resin 6 | 50 | 500 | 410 | 250 | 310 | 80 | — | 40 |
| polyester resin 7 | — | 500 | 460 | 280 | 85 | 50 | 75 | 40 |
| polyester resin 8 | — | 500 | 460 | 280 | 220 | 50 | — | 30 |
| polyester resin 9 | 50 | 500 | 410 | 420 | 100 | — | 60 | 40 |
| polyester resin 10 | 50 | 500 | 410 | 420 | 220 | — | — | 30 |
| polyester resin 11 | 50 | 400 | 410 | 400 | 150 | — | 10 | 25 |
| polyester resin 12 | 50 | 400 | 410 | 420 | 50 | — | 110 | 15 |
| polyester resin 13 | — | 500 | 460 | 330 | 40 | — | 120 | 40 |
| polyester resin 14 | — | 500 | 460 | 330 | 330 | — | — | — |
| polyester resin 15 | — | 500 | 460 | 210 | 160 | 120 | — | 40 |
| polyester resin 16 | 50 | 500 | 410 | 500 | 160 | — | — | 20 |
| polyester resin 17 | — | 500 | 460 | 300 | — | — | 160 | 40 |
| polyester resin 18 | — | 500 | 460 | — | 160 | 330 | — | 40 |

In the table, BPA-2PO is 2 mol adduct of propylene oxide on bisphenol A, and BPA-2EO is 2 mol adduct of ethylene oxide on bisphenol A

TABLE 1-2

| | results of polyester resin analysis | | | | |
|---|---|---|---|---|---|
| | acid monomer content (mass %) | | weight-average | acid | hydroxyl |
| | isophthalic | dodecenylsuccinic | molecular | value | value |
| | acid | acid | weight | mgKOH/g | mgKOH/g |
| polyester resin 1 | 22.1 | 10.7 | 32000 | 21.8 | 28.7 |
| polyester resin 2 | 22.3 | 4.7 | 30000 | 21.5 | 32.0 |
| polyester resin 3 | 21.2 | 16.0 | 31000 | 17.6 | 31.3 |
| polyester resin 4 | 15.4 | 3.4 | 32000 | 21.4 | 32.1 |
| polyester resin 5 | 16.8 | 10.7 | 33000 | 21.7 | 30.3 |
| polyester resin 6 | 15.2 | 18.9 | 31000 | 17.2 | 31.9 |
| polyester resin 7 | 18.8 | 5.7 | 30000 | 17.5 | 30.8 |
| polyester resin 8 | 18.2 | 14.3 | 35000 | 17.2 | 31.3 |
| polyester resin 9 | 26.6 | 6.3 | 32000 | 18.8 | 30.1 |
| polyester resin 10 | 25.8 | 13.5 | 30000 | 21.0 | 32.4 |
| polyester resin 11 | 27.7 | 10.4 | 32000 | 20.0 | 32.6 |
| polyester resin 12 | 28.9 | 3.4 | 31000 | 18.3 | 30.6 |
| polyester resin 13 | 22.1 | 2.7 | 31000 | 21.1 | 32.0 |
| polyester resin 14 | 20.4 | 20.4 | 32000 | 17.5 | 30.7 |
| polyester resin 15 | 14.1 | 10.7 | 33000 | 21.5 | 32.6 |
| polyester resin 16 | 30.5 | 9.8 | 34000 | 18.2 | 32.1 |
| polyester resin 17 | 20.5 | 0.0 | 31000 | 20.5 | 32.2 |
| polyester resin 18 | 0.0 | 10.7 | 31000 | 21.5 | 31.1 |

### Production Example for Ester Wax 1

100 parts of behenyl alcohol as alcohol monomer and 100 parts of behenic acid as carboxylic acid monomer were added to a reactor fitted with a thermometer, nitrogen introduction line, stirrer, Dean-Stark trap, and Dimroth condenser, and an esterification reaction was run for 15 hours at 200° C.

20 parts of toluene and 25 parts of isopropanol were added to the obtained ester compound; 190 parts of a 10% aqueous potassium hydroxide solution, which was an amount corresponding to 1.5-times the acid value of the ester compound, was added; and stirring was performed for 4 hours at 70° C. The aqueous layer was then removed. Washing was carried out by adding 20 parts of deionized water, stirring for 1 hour at 70° C., and removal of the aqueous layer. This washing process was repeated until the pH of the removed aqueous layer reached neutrality.

The solvent was subsequently removed by pressure reduction using conditions of 200° C. and 1 kPa, thus yielding behenyl behenate (ester compound 1), which was the final target and is an ester compound of behenyl alcohol and behenic acid. The properties of the obtained ester wax 1 are given in Table 2.

### Production Example for Ester Waxes 2 and 3

Ester waxes 2 and 3 were obtained proceeding as in the Production Example for Ester Wax 1, but changing the monomer so as to obtain the compounds of Table 2. The properties of the obtained ester waxes 2 and 3 are given in Table 2.

### Ester Wax 4

Refined Carnauba Wax Special No. 1 Powder from Nippon Wax Co., Ltd., was used as ester wax 4.

The results of measurement by GPC analysis of the molecular weight of the ester wax were a molecular weight distributed in the range of 650 to 1050 with a peak molecular weight of 850; the melting point was 83° C.

TABLE 2

| | | molecular | melting |
|---|---|---|---|
| | structure | weight | point |
| ester wax 1 | behenyl behenate | 649 | 73° C. |
| ester wax 2 | dibehenyl sebacate | 824 | 73° C. |
| ester wax 3 | 1,6-hexandiol distearate | 651 | 57° C. |
| ester wax 4 | carnauba wax | *850 | 83° C. |
| | (main component: myricyl cerotate) | | |

*Molecular weight of carnauba wax indicates peak molecular weight.

### Synthesis of Compound A1

280 parts by mass of 1-dodecanol and 15.5 parts by mass of potassium hydroxide were introduced into a 2-L autoclave; water removal was performed at 115° C. and 10.5 kPa; and an addition reaction was then run at 150° C. while carrying out the indentation of 720 parts by mass of ethylene oxide at 0.3 MPa. After the completion of the reaction, maturation was carried out for 6 hours at the same reaction temperature; this was followed by cooling to 80° C. 250 parts by mass of a synthetic adsorbent (Kyowaad 600S, Kyowa Chemical Industry Co., Ltd.) was added to the resulting reaction composition and a treatment was run for 1 hour at 4.0 kPa; subsequent removal of the catalyst by filtration afforded the compound A1 shown in Table 3.

### Synthesis of Compounds A2 to A10

Compounds A2 to A10 were obtained proceeding as in the compound A1 synthesis example, but changing the raw material used in the compound A1 synthesis example as shown in Table 3. Compounds A2 to A10 are shown in Table 3.

### Synthesis of Compound A11

100 parts by mass of compound A1, 5 parts by mass of 5% Pt-1% Bi/C (Lot TP-2/0230, Evonik) as catalyst, and 420 parts by mass of deionized water were introduced into a 1000-mL five-neck flask equipped with a reflux condenser, a dissolved oxygen concentration meter, and a stirring blade. The temperature was then raised to 70° C. under a nitrogen current while stirring at a condition of 400 rpm, and the nitrogen flow was continued for 15 minutes after reaching 70° C. Switching to oxygen was then carried out and a reaction was run under a flow condition of 90 mL/minute for 18 hours to give compound A11. Compound A11 is shown in Table 3.

TABLE 3

| | | | | | | average number |
|---|---|---|---|---|---|---|
| | | | | | | of moles of |
| | | type of | alkyl alcohol | ethylene oxide | | addition |
| | | alkyl alcohol | (parts by mass) | (parts by mass) | X | n or m |
| compound A1 | formula (2) | 1-dodecanol | 280 | 720 | H | 10 |
| compound A2 | formula (2) | 1-butanol | 280 | 720 | H | 4 |
| compound A3 | formula (2) | 1-octanol | 280 | 720 | H | 7 |
| compound A4 | formula (2) | 1-dodecanol | 130 | 870 | H | 26 |
| compound A5 | formula (2) | 1-dodecanol | 70 | 930 | H | 52 |
| compound A6 | formula (2) | 1-dodecanol | 60 | 940 | H | 62 |
| compound A7 | formula (2) | 1-octadecanol | 200 | 800 | H | 23 |
| compound A8 | formula (2) | 1-docosanol | 200 | 800 | H | 27 |
| compound A9 | formula (2) | 1-octacosanol | 200 | 800 | H | 35 |
| compound A10 | formula (3) | nonylphenol | 320 | 680 | H | 10 |
| compound A11 | formula (2) | 1-dodecanol | 280 | 720 | CH₂COOH | 9 |

The number of carbons in the alkyl group of the alkyl alcohol corresponds to R³ and R⁴ in formulas (2) and (3). A¹ and A² in compounds A2 to A11 is the ethylene group.

### Preparation of Resin Particle Dispersion of Polyester Resin 1

50 parts by mass of methyl ethyl ketone and 20 parts by mass of isopropyl alcohol were introduced into a container. 100 parts by mass of the polyester resin 1 was then gradually introduced and stirring was performed to bring about complete dissolution, yielding a polyester resin 1 solution. The container containing this polyester resin 1 solution was held at 65° C. and, while stirring, phase inversion emulsification was performed by gradually adding a 10% aqueous ammonia solution dropwise to provide a total of 5 parts and gradually adding 230 parts of deionized water dropwise at a rate of 10 mL/min. Solvent removal was performed under reduced pressure on an evaporator to obtain a resin particle dispersion of polyester resin 1. When the particle diameter of this resin particle dispersion of polyester resin 1 was measured using a particle size analyzer (LA-950, Horiba, Ltd.), the volume-average particle diameter of the resin particle dispersion of polyester resin 1 was 105 nm. The solids fraction of the resin particle dispersion of polyester resin 1 was adjusted with deionized water to 20 mass %.

### Preparation of a Resin Fine Particle Dispersion of Polyester Resin 2 to a Resin Particle Dispersion of Polyester Resin 18

Resin fine particle dispersion of polyester resin 2 to resin particle dispersion of polyester resin 18 were prepared proceeding as in “Preparation of resin particle dispersion of polyester resin 1”, but changing the polyester resin 1 used in “Preparation of resin particle dispersion of polyester resin 1” to polyester resin 2 to 18, respectively.

### Preparation of Colorant Particle-Dispersed Solution

Copper phthalocyanine (Pigment Blue 15:3): 45 parts
Ionic surfactant Neogen RK (manufactured by DKS Co., Ltd.): 5 parts
Ion-exchanged water: 190 parts

These components were mixed, and were dispersed for 1 hour using a Nanomizer high-pressure impact-type disperser (Yoshida Kikai Co., Ltd.) to prepare an aqueous dispersion (colorant fine particle dispersion) in which the colorant was dispersed and having a colorant fine particle concentration of 20 mass %.

### Preparation of Hydrocarbon Wax Particle Dispersion

hydrocarbon wax (HNP-9, Nippon Seiro Co., Ltd.) 45 parts
Neogen RK ionic surfactant (Dai-ichi Kogyo Seiyaku Co., Ltd.) 5 parts
deionized water 190 parts

The preceding were introduced into a stirrer-equipped mixing vessel and then heated to 90° C., and a dispersion treatment was run for 60 minutes while circulating to a ClearMix W-Motion (M Technique Co., Ltd.). The conditions for the dispersion treatment were as follows.
rotor outer diameter: 3 cm
clearance: 0.3 mm
rotor rotation rate: 19,000 r/min
screen rotation rate: 19,000 r/min

After the dispersion treatment, cooling to 40° C. was carried out under cooling treatment conditions of a rotor rotation rate of 1000 r/min, a screen rotation rate of 0 r/min, and a cooling rate of 10° C./min, to yield a hydrocarbon wax dispersion having a solids fraction of 20 mass % and a volume-average particle diameter of 160 nm.

### Preparation of Ester Wax Dispersion 1

ester wax 1 45 parts
Neogen RK ionic surfactant (Dai-ichi Kogyo Seiyaku Co., Ltd.) 5 parts
deionized water 190 parts

The preceding were introduced into a stirrer-equipped mixing vessel and then heated to 90° C., and a dispersion treatment was run for 60 minutes while circulating to a ClearMix W-Motion (M Technique Co., Ltd.). The conditions for the dispersion treatment were as follows.
rotor outer diameter: 3 cm
clearance: 0.3 mm
rotor rotation rate: 19,000 r/min
screen rotation rate: 19,000 r/min

After the dispersion treatment, cooling to 40° C. was carried out under cooling treatment conditions of a rotor rotation rate of 1000 r/min, a screen rotation rate of 0 r/min, and a cooling rate of 10° C./min, to yield an ester wax dispersion 1 having a solids fraction of 20 mass % and a volume-average particle diameter of 170 nm.

### Preparation of Ester Wax Dispersions 2 to 4

Ester wax dispersions 2 to 4 were obtained proceeding as in “Preparation of ester wax dispersion 1”, but changing the ester wax 1 to ester wax 2 to 4, respectively.

### Production of Toner Particle 1

| | | |
|---|---|---|
| resin particle dispersion of polyester resin 1 | 750 | parts |
| colorant particle dispersion | 70 | parts |
| hydrocarbon wax dispersion | 30 | parts |
| ester wax dispersion 1 | 120 | parts |
| deionized water | 1000 | parts |

First, as a core forming step, the above materials were put into a round stainless steel flask and mixed. Subsequently, a homogenizer ULTRA-TURRAX T50 (manufactured by IKA) was used to disperse at 5000 r/min for 10 min. After adding a 1.0% aqueous nitric acid solution and adjusting the pH to 3.0, heating was performed to 45° C. while using a stirring blade in a water bath for heating and adjusting, as appropriate, the number of revolutions.

The volume average particle diameter of the formed aggregated particles was confirmed, as appropriate, using Coulter Multisizer III, and when the aggregated particles (core) having a size of 5.0 m were formed, a shell forming step was performed by adding the following materials and further stirring for 1 h to form shells.

| | |
|---|---|
| resin particle dispersion of polyester resin 1 | 250 parts |
| deionized water | 300 parts |
| 3.0 mass % aqueous solution of compound A1 | 100 parts |
| 2.0 mass % aqueous borax solution | 50 parts |

(borax, sodium tetraborate decahydrate, FUJIFILM Wako Pure Chemical Corporation)

This was followed by a spheroidizing step in which the pH was brought to 9.0 using a 5% aqueous sodium hydroxide solution and heating to 90° C. was carried out while continuing to stir.

The average circularity of the aggregated particles that had formed was then measured as appropriate using an “FPIA-3000” (Sysmex Corporation) flow particle image analyzer.

Heating was performed until the average circularity of the aggregated particles reached 0.970 (a heating time of 3 hours was carried out), after which a cooling step was implemented in which cooling to 25° C. was carried out by the rapid introduction of ice to provide a cooling rate of at least 10° C./second, thereby yielding a toner particle 1 dispersion.

A neutralization treatment was performed by adjusting the toner particle 1 dispersion to pH=5.0 to 7.0 by the addition of hydrochloric acid; this was followed by solid-liquid separation at a pressure of 0.3 MPa using a pressure filter to obtain a toner cake. This was slurried with deionized water to reproduce a dispersion, after which solid-liquid separation was carried out at a pressure of 0.3 MPa using the aforementioned filter to obtain a toner cake. Washing was carried out by the addition of 2,000 parts by mass of deionized water to the toner cake and pressurization again to 0.3 MPa and the execution of a water removal step. Air drying was carried out while maintaining 0.2 MPa, after which the toner cake was removed and was subjected to a pulverization treatment.

The pulverized toner cake was dried for 12 hours in a 40° C. vacuum dryer, followed by a classification process to yield toner particle 1. The production conditions and analytic results for toner particle 1 are reported in Table 4-1, Table 4-2, Table 5-1, and Table 5-2.

### Production of Toner Particles 2 to 57 and Comparative Toner Particles 1 to 8 (Toner Particles 58 to 65)

Toner particles 2 to 65 were obtained proceeding in the same manner as for the production of toner particle 1, but changing to the conditions shown in Table 4. The production conditions and analytic results for toner particles 2 to 57 and comparative toner particles 1 to 8 (toner particles 58 to 65) are given in Table 4-1, Table 4-2, Table 5-1, and Table 5-2.

TABLE 4-1

| | core formation | | | | | shell formation | | | | |
|---|---|---|---|---|---|---|---|---|---|---|
| toner | polyester | | hydrocarbon | | | polyester | | | | borax |
| particle | resin | | wax | ester wax | | resin | | compound A | | (parts |
| No. | No. | parts | parts | type | parts | No. | parts | type | parts | by mass) |
| 1 | 1 | 750 | 30 | behenyl behenate | 120 | 1 | 250 | compound A1 | 100 | 50 |
| 2 | 1 | 750 | 30 | behenyl behenate | 120 | 1 | 250 | — | — | 50 |
| 3 | 1 | 750 | 30 | behenyl behenate | 120 | 1 | 250 | compound A1 | 30 | 50 |
| 4 | 1 | 750 | 30 | behenyl behenate | 120 | 1 | 250 | compound A1 | 50 | 50 |
| 5 | 1 | 750 | 30 | behenyl behenate | 120 | 1 | 250 | compound A1 | 300 | 50 |
| 6 | 1 | 750 | 30 | behenyl behenate | 120 | 1 | 250 | compound A1 | 450 | 50 |
| 7 | 1 | 750 | 30 | behenyl behenate | 120 | 1 | 250 | compound A1 | 1000 | 50 |
| 8 | 1 | 750 | 30 | behenyl behenate | 120 | 1 | 250 | compound A1 | 1500 | 50 |
| 9 | 1 | 750 | 30 | behenyl behenate | 120 | 1 | 250 | compound A2 | 100 | 50 |
| 10 | 1 | 750 | 30 | behenyl behenate | 120 | 1 | 250 | compound A3 | 100 | 50 |
| 11 | 1 | 750 | 30 | behenyl behenate | 120 | 1 | 250 | compound A4 | 100 | 50 |
| 12 | 1 | 750 | 30 | behenyl behenate | 120 | 1 | 250 | compound A5 | 100 | 50 |
| 13 | 1 | 750 | 30 | behenyl behenate | 120 | 1 | 250 | compound A6 | 100 | 50 |
| 14 | 1 | 750 | 30 | behenyl behenate | 120 | 1 | 250 | compound A7 | 100 | 50 |
| 15 | 1 | 750 | 30 | behenyl behenate | 120 | 1 | 250 | compound A8 | 100 | 50 |
| 16 | 1 | 750 | 30 | behenyl behenate | 120 | 1 | 250 | compound A9 | 100 | 50 |
| 17 | 1 | 750 | 30 | behenyl behenate | 120 | 1 | 250 | compound A10 | 100 | 50 |
| 18 | 1 | 750 | 30 | behenyl behenate | 120 | 1 | 250 | compound A11 | 100 | 50 |
| 19 | 1 | 750 | 7.5 | behenyl behenate | 25 | 1 | 250 | compound A1 | 100 | 50 |
| 20 | 1 | 750 | 7.5 | behenyl behenate | 35 | 1 | 250 | compound A1 | 100 | 50 |
| 21 | 1 | 750 | 15 | behenyl behenate | 60 | 1 | 250 | compound A1 | 100 | 50 |
| 22 | 1 | 750 | 55 | behenyl behenate | 75 | 1 | 250 | compound A1 | 100 | 50 |
| 23 | 1 | 750 | 40 | behenyl behenate | 100 | 1 | 250 | compound A1 | 100 | 50 |
| 24 | 1 | 750 | 50 | behenyl behenate | 100 | 1 | 250 | compound A1 | 100 | 50 |
| 25 | 1 | 750 | 55 | behenyl behenate | 100 | 1 | 250 | compound A1 | 100 | 50 |
| 26 | 1 | 750 | 80 | behenyl behenate | 120 | 1 | 250 | compound A1 | 100 | 50 |
| 27 | 1 | 750 | 20 | behenyl behenate | 120 | 1 | 250 | compound A1 | 100 | 50 |
| 28 | 1 | 750 | 35 | behenyl behenate | 140 | 1 | 250 | compound A1 | 100 | 50 |
| 29 | 1 | 750 | 115 | behenyl behenate | 150 | 1 | 250 | compound A1 | 100 | 50 |
| 30 | 1 | 750 | 30 | behenyl behenate | 180 | 1 | 250 | compound A1 | 100 | 50 |
| 31 | 1 | 750 | 50 | behenyl behenate | 300 | 1 | 250 | compound A1 | 100 | 50 |
| 32 | 1 | 750 | 100 | behenyl behenate | 300 | 1 | 250 | compound A1 | 100 | 50 |
| 33 | 1 | 750 | 30 | behenyl behenate | 120 | 1 | 250 | compound A1 | 100 | — |
| 34 | 1 | 750 | 30 | behenyl behenate | 120 | 1 | 250 | compound A1 | 100 | 25 |
| 35 | 1 | 500 | 30 | behenyl behenate | 120 | 1 | 500 | compound A1 | 100 | 200 |
| 36 | 1 | 500 | 30 | behenyl behenate | 120 | 1 | 500 | compound A1 | 100 | 350 |

In the table, the number of parts indicates the number of parts by mass of the particular dispersion and aqueous solution. The numerical values in the borax column indicate the number of parts by mass of the 2.0 mass % aqueous borax solution.

TABLE 4-2

| | core formation | | | | | shell formation | | | | |
|---|---|---|---|---|---|---|---|---|---|---|
| toner | polyester | | hydrocarbon | | | polyester | | | | borax |
| particle | resin | | wax | ester wax | | resin | | compound A | | (parts |
| No. | No. | parts | parts | type | parts | No. | parts | type | parts | by mass) |
| 37 | 1 | 800 | 30 | behenyl behenate | 120 | 1 | 200 | compound A1 | 100 | — |
| 38 | 1 | 900 | 30 | behenyl behenate | 120 | 1 | 100 | compound A1 | 100 | — |
| 39 | 1 | 1000 | 30 | behenyl behenate | 120 | — | — | — | — | — |
| 40 | 2 | 1000 | 30 | behenyl behenate | 120 | — | — | — | — | — |
| 41 | 3 | 1000 | 30 | behenyl behenate | 120 | — | — | — | — | — |
| 42 | 4 | 1000 | 30 | behenyl behenate | 120 | — | — | — | — | — |
| 43 | 5 | 1000 | 30 | behenyl behenate | 120 | — | — | — | — | — |
| 44 | 6 | 1000 | 30 | behenyl behenate | 120 | — | — | — | — | — |
| 45 | 7 | 1000 | 30 | behenyl behenate | 120 | — | — | — | — | — |
| 46 | 8 | 1000 | 30 | behenyl behenate | 120 | — | — | — | — | — |
| 47 | 9 | 1000 | 30 | behenyl behenate | 120 | — | — | — | — | — |
| 48 | 10 | 1000 | 30 | behenyl behenate | 120 | — | — | — | — | — |
| 49 | 11 | 1000 | 30 | behenyl behenate | 120 | — | — | — | — | — |
| 50 | 12 | 1000 | 30 | behenyl behenate | 120 | — | — | — | — | — |
| 51 | 1 | 500 | 30 | behenyl behenate | 120 | — | — | — | — | — |
| | 17 | 500 | | | | | | | | |
| 52 | 12 | 500 | 30 | behenyl behenate | 120 | — | — | — | — | — |
| | 17 | 500 | | | | | | | | |
| 53 | 6 | 500 | 30 | behenyl behenate | 120 | — | — | — | — | — |
| | 18 | 500 | | | | | | | | |
| 54 | 12 | 500 | 30 | behenyl behenate | 180 | — | — | — | — | — |
| | 17 | 500 | | | | | | | | |
| 55 | 1 | 1000 | 30 | dibehenyl sebacate | 120 | — | — | — | — | — |
| 56 | 1 | 1000 | 30 | 1,6-hexanediol distearate | 120 | — | — | — | — | — |
| 57 | 1 | 1000 | 30 | carnauba max (myricyl cerotate) | 120 | — | — | — | — | — |
| 58 | 1 | 750 | — | behenyl behenate | 150 | 1 | 250 | compound A1 | 100 | 50 |
| 59 | 1 | 750 | 20 | behenyl behenate | 150 | 1 | 250 | compound A1 | 100 | 50 |
| 60 | 1 | 750 | 35 | behenyl behenate | 40 | 1 | 250 | compound A1 | 100 | 50 |
| 61 | 1 | 750 | 50 | behenyl behenate | 60 | 1 | 250 | compound A1 | 100 | 50 |
| 62 | 13 | 750 | 30 | behenyl behenate | 120 | 13 | 250 | compound A1 | 100 | 50 |
| 63 | 14 | 750 | 30 | behenyl behenate | 120 | 14 | 250 | compound A1 | 100 | 50 |
| 64 | 15 | 750 | 30 | behenyl behenate | 120 | 15 | 250 | compound A1 | 100 | 50 |
| 65 | 16 | 750 | 30 | behenyl behenate | 120 | 16 | 250 | compound A1 | 100 | 50 |

In the table, the number of parts indicates the number of parts by mass of the particular dispersion and aqueous solution. The numerical values in the borax column indicate the number of parts by mass of the 2.0 mass % aqueous borax solution.

TABLE 5-1

| | | | ester wax content | | | | | | boron |
|---|---|---|---|---|---|---|---|---|---|
| | | | | ester wax | | | extraction | wax value | atom |
| toner | toner | | W1 | | W2 | | amount of | in vicinity | content |
| particle | D4 | D | (parts by | | (parts by | | compound A | of surface | (mass- |
| No. | (μm) | (mass %) | mass) | type | mass) | W1/W2 | (mass-ppm) | (area %) | ppm) |
| 1 | 6.7 | 10.7 | 3.0 | behenyl behenate | 12.0 | 0.25 | 120 | 0.1 | 5.3 |
| 2 | 6.7 | 10.7 | 3.0 | behenyl behenate | 12.0 | 0.25 | 0 | 0.0 | 5.0 |
| 3 | 6.8 | 10.7 | 3.0 | behenyl behenate | 12.0 | 0.25 | 35 | 0.1 | 5.2 |
| 4 | 6.6 | 10.7 | 3.0 | behenyl behenate | 12.0 | 0.25 | 60 | 0.0 | 5.3 |
| 5 | 6.8 | 10.7 | 3.0 | behenyl behenate | 12.0 | 0.25 | 280 | 0.0 | 5.3 |
| 6 | 6.7 | 10.7 | 3.0 | behenyl behenate | 12.0 | 0.25 | 470 | 0.1 | 5.2 |
| 7 | 6.6 | 10.7 | 3.0 | behenyl behenate | 12.0 | 0.25 | 870 | 0.0 | 5.2 |
| 8 | 6.7 | 10.7 | 3.0 | behenyl behenate | 12.0 | 0.25 | 1200 | 0.0 | 5.1 |
| 9 | 6.7 | 10.7 | 3.0 | behenyl behenate | 12.0 | 0.25 | 60 | 0.0 | 5.0 |
| 10 | 6.7 | 10.7 | 3.0 | behenyl behenate | 12.0 | 0.25 | 70 | 0.1 | 5.1 |
| 11 | 6.7 | 10.7 | 3.0 | behenyl behenate | 12.0 | 0.25 | 160 | 0.0 | 5.2 |
| 12 | 6.7 | 10.7 | 3.0 | behenyl behenate | 12.0 | 0.25 | 270 | 0.0 | 5.3 |
| 13 | 6.7 | 10.7 | 3.0 | behenyl behenate | 12.0 | 0.25 | 310 | 0.1 | 5.2 |
| 14 | 6.7 | 10.7 | 3.0 | behenyl behenate | 12.0 | 0.25 | 130 | 0.0 | 5.2 |
| 15 | 6.7 | 10.7 | 3.0 | behenyl behenate | 12.0 | 0.25 | 190 | 0.0 | 5.1 |
| 16 | 6.7 | 10.7 | 3.0 | behenyl behenate | 12.0 | 0.25 | 180 | 0.0 | 5.1 |
| 17 | 6.8 | 10.7 | 3.0 | behenyl behenate | 12.0 | 0.25 | 130 | 0.1 | 5.1 |
| 18 | 6.6 | 10.7 | 3.0 | behenyl behenate | 12.0 | 0.25 | 130 | 0.1 | 5.1 |
| 19 | 6.7 | 10.7 | 0.8 | behenyl behenate | 2.5 | 0.30 | 140 | 0.0 | 5.1 |
| 20 | 6.7 | 10.7 | 0.8 | behenyl behenate | 3.5 | 0.21 | 130 | 0.0 | 5.1 |
| 21 | 6.7 | 10.7 | 1.5 | behenyl behenate | 6.0 | 0.25 | 150 | 0.1 | 5.1 |
| 22 | 6.7 | 10.7 | 5.5 | behenyl behenate | 7.5 | 0.73 | 130 | 0.0 | 5.2 |
| 23 | 6.7 | 10.7 | 4.0 | behenyl behenate | 10.0 | 0.40 | 140 | 0.0 | 5.0 |
| 24 | 6.8 | 10.7 | 5.0 | behenyl behenate | 10.0 | 0.50 | 130 | 0.0 | 5.3 |
| 25 | 6.8 | 10.7 | 5.5 | behenyl behenate | 10.0 | 0.55 | 120 | 0.0 | 5.2 |
| 26 | 6.8 | 10.7 | 8.0 | behenyl behenate | 12.0 | 0.67 | 130 | 0.0 | 5.1 |
| 27 | 6.6 | 10.7 | 2.0 | behenyl behenate | 12.0 | 0.17 | 140 | 0.0 | 5.0 |
| 28 | 6.7 | 10.7 | 3.5 | behenyl behenate | 14.0 | 0.25 | 130 | 0.0 | 5.3 |
| 29 | 6.7 | 10.7 | 11.5 | behenyl behenate | 15.0 | 0.77 | 120 | 0.0 | 5.1 |
| 30 | 6.6 | 10.7 | 3.0 | behenyl behenate | 18.0 | 0.17 | 130 | 0.0 | 5.1 |
| 31 | 6.7 | 10.7 | 5.0 | behenyl behenate | 30.0 | 0.17 | 140 | 0.0 | 5.3 |
| 32 | 6.7 | 10.7 | 10.0 | behenyl behenate | 30.0 | 0.33 | 130 | 0.1 | 5.1 |
| 33 | 6.6 | 10.7 | 3.0 | behenyl behenate | 12.0 | 0.25 | 140 | 0.6 | 0.0 |
| 34 | 6.7 | 10.7 | 3.0 | behenyl behenate | 12.0 | 0.25 | 130 | 0.3 | 2.5 |
| 35 | 6.7 | 10.7 | 3.0 | behenyl behenate | 12.0 | 0.25 | 130 | 0.0 | 30.7 |
| 36 | 6.8 | 10.7 | 3.0 | behenyl behenate | 12.0 | 0.25 | 150 | 0.0 | 53.4 |

TABLE 5-2

| | | | ester wax content | | | | | | boron |
|---|---|---|---|---|---|---|---|---|---|
| | | | | ester wax | | | extraction | wax value | atom |
| toner | toner | | W1 | | W2 | | amount of | in vicinity | content |
| particle | D4 | D | (parts by | | (parts by | | compound A | of surface | (mass- |
| No. | (μm) | (mass %) | mass) | type | mass) | W1/W2 | (mass-ppm) | (area %) | ppm) |
| 37 | 6.6 | 10.7 | 3.0 | behenyl behenate | 12.0 | 0.25 | 110 | 0.9 | 0.0 |
| 38 | 6.7 | 10.1 | 3.0 | behenyl behenate | 12.0 | 0.25 | 110 | 1.8 | 0.0 |
| 39 | 6.6 | 10.7 | 3.0 | behenyl behenate | 12.0 | 0.25 | 0 | 4.2 | 0.0 |
| 40 | 6.6 | 4.7 | 3.0 | behenyl behenate | 12.0 | 0.25 | 0 | 4.4 | 0.0 |
| 41 | 6.6 | 16.0 | 3.0 | behenyl behenate | 12.0 | 0.25 | 0 | 4.3 | 0.0 |
| 42 | 6.6 | 3.4 | 3.0 | behenyl behenate | 12.0 | 0.25 | 0 | 4.5 | 0.0 |
| 43 | 6.7 | 10.7 | 3.0 | behenyl behenate | 12.0 | 0.25 | 0 | 4.0 | 0.0 |
| 44 | 6.8 | 18.9 | 3.0 | behenyl behenate | 12.0 | 0.25 | 0 | 4.4 | 0.0 |
| 45 | 6.6 | 5.7 | 3.0 | behenyl behenate | 12.0 | 0.25 | 0 | 4.8 | 0.0 |
| 46 | 6.6 | 14.3 | 3.0 | behenyl behenate | 12.0 | 0.25 | 0 | 4.4 | 0.0 |
| 47 | 6.7 | 6.3 | 3.0 | behenyl behenate | 12.0 | 0.25 | 0 | 4.5 | 0.0 |
| 48 | 6.6 | 13.5 | 3.0 | behenyl behenate | 12.0 | 0.25 | 0 | 4.8 | 0.0 |
| 49 | 6.7 | 10.4 | 3.0 | behenyl behenate | 12.0 | 0.25 | 0 | 4.0 | 0.0 |
| 50 | 6.6 | 3.4 | 3.0 | behenyl behenate | 12.0 | 0.25 | 0 | 4.2 | 0.0 |
| 51 | 6.6 | 5.4 | 3.0 | behenyl behenate | 12.0 | 0.25 | 0 | 4.4 | 0.0 |
| 52 | 6.7 | 1.7 | 3.0 | behenyl behenate | 12.0 | 0.25 | 0 | 4.5 | 0.0 |
| 53 | 6.8 | 14.8 | 3.0 | behenyl behenate | 12.0 | 0.25 | 0 | 4.7 | 0.0 |
| 54 | 6.7 | 1.7 | 3.0 | behenyl behenate | 18.0 | 0.17 | 0 | 4.9 | 0.0 |
| 55 | 6.7 | 10.7 | 3.0 | dibehenyl sebacate | 12.0 | 0.25 | 0 | 4.2 | 0.0 |
| 56 | 6.7 | 10.7 | 3.0 | 1,6-hexanediol distearate | 12.0 | 0.25 | 0 | 4.2 | 0.0 |
| 57 | 7.7 | 10.7 | 3.0 | carnauba max (myricyl cerotate) | 12.0 | 0.25 | 0 | 4.2 | 0.0 |
| 58 | 6.6 | 10.7 | 0.0 | behenyl behenate | 15.0 | 0.00 | 280 | 0.1 | 5.3 |
| 59 | 6.7 | 10.7 | 2.0 | behenyl behenate | 15.0 | 0.13 | 460 | 0.0 | 5.0 |
| 60 | 6.6 | 10.7 | 3.5 | behenyl behenate | 4.0 | 0.88 | 460 | 0.0 | 5.3 |
| 61 | 6.7 | 10.7 | 5.0 | behenyl behenate | 6.0 | 0.83 | 460 | 0.0 | 5.1 |
| 62 | 6.7 | 2.7 | 3.0 | behenyl behenate | 12.0 | 0.25 | 460 | 0.0 | 5.3 |
| 63 | 6.8 | 20.4 | 3.0 | behenyl behenate | 12.0 | 0.25 | 460 | 0.0 | 5.2 |
| 64 | 6.6 | 10.7 | 3.0 | behenyl behenate | 12.0 | 0.25 | 460 | 0.0 | 5.1 |
| 65 | 6.8 | 9.8 | 3.0 | behenyl behenate | 12.0 | 0.25 | 460 | 0.0 | 5.2 |

In the table, D indicates the content, with reference to the mass of the binder resin, of the monomer unit corresponding to dodecenylsuccinic acid.

When each of the obtained toner particles was analyzed using the procedure described in the preceding, the content of isophthalic acid unit and content of dodecenylsuccinic acid in the polyester resin A comprised in the particular toner particle were the same as the analytic values in Table 1-2.

### Example 1

| | | |
|---|---|---|
| toner particle 1: | 100.0 | parts |
| RX10 (Nippon Aerosil Co., Ltd.): | 2.0 | parts |
| RX200 (Nippon Aerosil Co., Ltd.): | 1.5 | parts |

A toner 1 was obtained by mixing these materials for 7.5 minutes at 3,000 rpm using an FM10C Henschel mixer (Nippon Coke & Engineering Co., Ltd.).

The obtained toner 1 was evaluated using the following procedures.

### Reproduction of the Long-Term Toner Storage Condition

The long-term storage condition is normally the condition of standing 2 to 3 years in a normal temperature environment; however, storage was carried out in the present disclosure using the following procedure in order to accelerate and reproduce the long-term toner storage condition.

First, toner not subjected to reproduction of the long-term storage condition is designated as the initial toner. 200 g of initial toner placed in a container was held for 20 days in a thermostated chamber at 40° C./90% RH. Toner further aged at 23° C./40% RH for 3 days was subjected, as a long-term storage toner, to evaluation of the toner.

### Measurement of the Charge Quantity on the Toner

The charge quantity was first measured as follows.

9.5 g of a carrier for charge quantity measurement (reference carrier from The Imaging Society of Japan: spherical carrier N-01, surface-treated ferrite core) is weighed into a 50-mL polyethylene container. 0.5 g of the toner to be measured is then weighed into the polyethylene container containing this carrier and the container is closed with a cap. This container is subsequently set in a shaker (Model YS-LD from Yayoi Co. Ltd.) and shaking is carried out setting the time whereby the prescribed number of times is achieved at a shaking condition of 100 times/minute. Then, within 1 minute, 0.4 g of the shaken sample is introduced into the metal measurement container 2 shown in the FIGURE, which has a 500-mesh screen 3 at the bottom, and the metal lid 4 is applied. The mass of the entire measurement container 2 at this point is measured to give W1 (g). The potential at the electrometer 9 at this time point is designated 0 V (volt).

Suction is then drawn through a suction port 7 with a suction device 1 (at least the part in contact with the measurement container 2 is an insulator), and the pressure at a vacuum gauge 5 is brought to 2.5 kPa (±0.1 kPa) within 10 seconds by adjustment with an air quantity control valve 6. The time from after the measurement of W1 to the start of suction is within 30 seconds. Suction is carried out for 3 minutes and toner particles are removed by the suction. The potential at the electrometer 9 at this time is designated V (volt). Here, 8 is a capacitor and its capacitance is designated C (μF).

The mass of the overall measurement container after suction is measured and the value at this point is designated W2 (g). The charge quantity (mC/kg) on the toner in the sample is calculated using the following formula.

$$charge quantity ( mC / kg ) = C \times V / ( W 1 - W 2 )$$

The charge quantity was measured in a normal-temperature, normal-humidity environment (temperature=23° C., humidity=50% RH:NN environment).

### Evaluation of the Toner Charging Performance

The charging performance of the toner, as described above, was evaluated according to the following criteria.
Charge rise performance of the initial toner

The charge rising performance of the initial toner was evaluated with shaking using 100 times and 300 times for the number of excursions in the above-described measurement of the charge quantity on the toner.

The evaluation then used the change ratio Q2/Q1×100 where the charge quantity Q1 after 300 times was used as reference and the charge quantity Q2 was measured at 100 times.

### Overcharging Behavior of the Initial Toner

The overcharging behavior of the initial toner was evaluated with shaking using 300 times and 1200 times for the number of excursions in the above-described measurement of the charge quantity on the toner.

The evaluation then used the change ratio Q3/Q1×100 where the charge quantity Q1 after 300 times was used as reference and the charge quantity Q3 was measured at 1200 times.

### Charge Maintenance for the Long-Term Storage Toner

Charge maintenance for the long-term storage toner was evaluated using the change ratio Q4/Q1×100 where Q1 is the charge quantity measured on the initial toner in the above-described measurement of the toner charge quantity after shaking 300 times and Q4 is the charge quantity measured on the long-term storage toner after shaking 300 times.

### Toner Image Examination

### Evaluation of the Fixing Performance

The toner-filled process cartridge was held for 48 hours at 25° C. and a humidity of 40% RH. An LBP-712Ci was used that had been modified to operate even with the fixing unit detached, and an unfixed image was output of an image pattern in which 10 mm×10 mm square images were evenly arranged at 9 points over the entire transfer paper. The toner laid-on level on the transfer paper was 0.80 mg/cm², and the lower limit fixation temperature and the upper limit fixation temperature were evaluated while changing the fixation temperature in 5° C. intervals in the fixation temperature range of 100° C. to 220° C. A4 paper (“Plover Bond paper”: 105 g/m², Fox River) was used as the transfer paper.

For the fixing unit, the fixing unit was removed to the outside from the LBP-712Ci and the outside fixing unit, set up to also operate outside the laser beam printer, was used. The outside fixing unit carried out fixing using a process speed condition of 360 mm/see with the fixation temperature being raised in 5° C. increments from 120° C. The fixed image was visually examined, and the lowest temperature at which cold offset was not produced was scored as the lower limit fixation temperature.

### Evaluation of Image Stability

In order to examine the influence exercised by the charge stability on the image, an evaluation was performed by carrying out image output with the initial toner and the long-term storage toner.

A machine provided by modification of a commercial LBP7700C laser beam printer from Canon, Inc. was used for image output. The modification was to make the rotation rate of the developing roller 360 mm/see by modifying the evaluation machine itself and the software.

200 g of the toner was filled into a toner cartridge of the LBP7700C and image output was performed with this toner cartridge in a normal-temperature, normal-humidity environment NN (25° C./50% RH).

As a result of the evaluations, toner, of the initial toner, that exhibited an excellent charge rising performance, had an excellent density stability, and, when 10 prints of a solid black image were continuously output, the image density of the first, fifth, and tenth prints was stable. In addition, toner, of the initial toner, that exhibited an excellent overcharging behavior, presented no change in the density of a solid black image immediately after 200 prints of a solid white image had been output after the output of the tenth print of the solid black image. Moreover, toner, of the long-term storage toner, that exhibited an excellent charge maintenance, had a stable image density for the first, fifth, and tenth prints, and in addition an image density was obtained that was the same as the results of the test carried out with the initial toner.

With regard to the charge rising performance Q2/Q1×100, overcharging behavior Q3/Q1×100, and charge maintenance Q4/Q1×100, a result of 70.0 to 130.0 was good, while less than 70.0 or greater than 130.0 appeared as an image defect.

The results of the evaluation for toner particle 1 are given in Tables 6-1 and 6-2.

TABLE 6-1

| | | evaluation of fixing | initial toner | | long-term storage toner |
|---|---|---|---|---|---|
| | toner | performance | charge rising | overcharging | charge maintenance |
| | particle | lower limit fixation | performance | behavior | performance |
| | No. | temperature (° C.) | Q2/Q1 × 100 | Q3/Q1 × 100 | Q4/Q1 × 100 |
| Example 1 | 1 | 130 | 96.8 | 102.4 | 98.0 |
| Example 2 | 2 | 140 | 91.5 | 126.5 | 85.0 |
| Example 3 | 3 | 140 | 95.5 | 113.8 | 91.0 |
| Example 4 | 4 | 135 | 96.5 | 112.8 | 98.0 |
| Example 5 | 5 | 130 | 94.5 | 103.5 | 92.0 |
| Example 6 | 6 | 130 | 85.0 | 101.1 | 88.0 |
| Example 7 | 7 | 125 | 81.0 | 102.3 | 82.0 |
| Example 8 | 8 | 125 | 76.0 | 99.9 | 77.0 |
| Example 9 | 9 | 140 | 96.8 | 122.0 | 87.0 |
| Example 10 | 10 | 135 | 97.5 | 113.1 | 91.0 |
| Example 11 | 11 | 130 | 87.3 | 99.5 | 88.0 |
| Example 12 | 12 | 125 | 83.5 | 100.3 | 79.0 |
| Example 13 | 13 | 125 | 78.5 | 99.5 | 73.0 |
| Example 14 | 14 | 130 | 91.3 | 99.2 | 81.0 |
| Example 15 | 15 | 130 | 96.2 | 112.9 | 81.0 |
| Example 16 | 16 | 135 | 96.0 | 113.0 | 83.0 |
| Example 17 | 17 | 130 | 96.7 | 102.4 | 100.0 |
| Example 18 | 18 | 130 | 96.7 | 102.4 | 100.0 |
| Example 19 | 19 | 155 | 91.5 | 115.5 | 88.0 |
| Example 20 | 20 | 160 | 93.0 | 106.5 | 90.0 |
| Example 21 | 21 | 145 | 95.2 | 100.2 | 95.0 |
| Example 22 | 22 | 145 | 97.5 | 105.3 | 88.0 |
| Example 23 | 23 | 130 | 98.5 | 108.5 | 98.0 |
| Example 24 | 24 | 130 | 97.9 | 106.0 | 97.0 |
| Example 25 | 25 | 130 | 98.6 | 108.5 | 95.0 |
| Example 26 | 26 | 140 | 84.5 | 111.0 | 86.0 |
| Example 27 | 27 | 130 | 95.8 | 100.5 | 79.0 |
| Example 28 | 28 | 130 | 95.9 | 105.5 | 90.0 |
| Example 29 | 29 | 140 | 91.5 | 107.7 | 76.0 |
| Example 30 | 30 | 125 | 92.5 | 109.1 | 74.0 |
| Example 31 | 31 | 125 | 88.5 | 104.5 | 78.0 |
| Example 32 | 32 | 130 | 87.5 | 109.5 | 93.0 |
| Example 33 | 33 | 130 | 95.8 | 100.3 | 90.0 |
| Example 34 | 34 | 130 | 95.5 | 105.5 | 93.0 |
| Example 35 | 35 | 140 | 95.3 | 111.2 | 99.0 |
| Example 36 | 36 | 150 | 94.5 | 110.5 | 99.0 |

TABLE 6-2

| | | evaluation of fixing | initial toner | | long-term storage toner |
|---|---|---|---|---|---|
| | toner | performance lower | charge rising | overcharging | charge maintenance |
| | particle | limit fixation | performance | behavior | performance |
| | No. | temperature (° C.) | Q2/Q1 × 100 | Q3/Q1 × 100 | Q4/Q1 × 100 |
| Example 37 | 37 | 130 | 95.5 | 100.3 | 88.0 |
| Example 38 | 38 | 125 | 94.5 | 100.5 | 84.0 |
| Example 39 | 39 | 135 | 91.5 | 108.9 | 98.0 |
| Example 40 | 40 | 155 | 94.0 | 115.2 | 87.0 |
| Example 41 | 41 | 125 | 95.2 | 110.9 | 90.0 |
| Example 42 | 42 | 165 | 88.5 | 119.5 | 78.0 |
| Example 43 | 43 | 135 | 88.7 | 109.8 | 95.0 |
| Example 44 | 44 | 125 | 92.8 | 104.3 | 82.0 |
| Example 45 | 45 | 150 | 89.5 | 115.1 | 91.0 |
| Example 46 | 46 | 130 | 99.9 | 110.5 | 92.0 |
| Example 47 | 47 | 145 | 90.4 | 109.0 | 95.0 |
| Example 48 | 48 | 130 | 85.3 | 117.1 | 93.0 |
| Example 49 | 49 | 135 | 88.5 | 110.8 | 96.0 |
| Example 50 | 50 | 160 | 90.5 | 118.6 | 79.0 |
| Example 51 | 51 | 150 | 96.5 | 97.6 | 89.0 |
| Example 52 | 52 | 175 | 88.7 | 122.4 | 74.0 |
| Example 53 | 53 | 140 | 90.5 | 109.0 | 91.0 |
| Example 54 | 54 | 165 | 88.5 | 101.8 | 91.0 |
| Example 55 | 55 | 140 | 92.5 | 101.8 | 83.5 |
| Example 56 | 56 | 150 | 88.5 | 95.1 | 89.3 |
| Example 57 | 57 | 155 | 85.5 | 99.8 | 73.0 |
| Comparative | 58 | 135 | 95.8 | 106.5 | 66.0 |
| Example 1 | | | | | |
| Comparative | 59 | 135 | 96.8 | 99.8 | 67.0 |
| Example 2 | | | | | |
| Comparative | 60 | 160 | 94.8 | 99.8 | 66.0 |
| Example 3 | | | | | |
| Comparative | 61 | 150 | 97.5 | 99.8 | 67.0 |
| Example 4 | | | | | |
| Comparative | 62 | 190 | 96.5 | 99.8 | 82.0 |
| Example 5 | | | | | |
| Comparative | 63 | 125 | 97.5 | 99.8 | 62.0 |
| Example 6 | | | | | |
| Comparative | 64 | 175 | 88.5 | 103.3 | 68.0 |
| Example 7 | | | | | |
| Comparative | 65 | 125 | 90.8 | 134.8 | 67.0 |
| Example 8 | | | | | |

### Examples 2 to 57, Comparative Examples 1 to 8

Toners 2 to 57 and comparative toners 1 to 8 were obtained by carrying out the same external addition treatment as for toner 1, using toner particles 2 to 57 and comparative toner particles 1 to 8 (toner particles 58 to 65). The same evaluations as for toner 1 were performed using each of the obtained toners. The results are given in Tables 6-1 and 6-2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2023-215503, filed Dec. 21, 2023, which is hereby incorporated by reference herein in its entirety.

What is claimed is:

1. A toner comprising a toner particle comprising a binder resin and a wax,
the binder resin comprises a polyester resin;
the wax comprises a hydrocarbon wax and an ester wax;
the ester wax comprises at least one compound selected from the group consisting of monoester compounds and diester compounds;
the polyester resin comprises a polyester resin A comprising a monomer unit corresponding to isophthalic acid and a monomer unit corresponding to dodecenylsuccinic acid;
a content of the monomer unit corresponding to isophthalic acid in the polyester resin A is 15.0 to 30.0 mass %;
a content of the monomer unit corresponding to dodecenylsuccinic acid in the polyester resin A is 3.0 to 20.0 mass %; and
when W1 denotes a content of the hydrocarbon wax per 100 parts by mass of the binder resin and W2 denotes a content of the ester wax per 100 parts by mass of the binder resin, the value of a ratio W1/W2 is 0.15 to 0.80.

2. The toner according to claim 1, wherein the molecular weight of the ester wax is 500 to 1,000.

3. The toner according to claim 1, wherein the content W1 of the hydrocarbon wax is 0.5 to 7.0 mass parts per 100 mass parts of the binder resin.

4. The toner according to claim 1, wherein the content W2 of the ester wax is 3.0 to 20.0 mass parts per 100 mass parts of the binder resin.

5. The toner according to claim 1, wherein a content of the monomer unit corresponding to dodecenylsuccinic acid is 3.0 to 20.0 mass % with reference to the mass of the binder resin.

6. The toner according to claim 1, wherein
the content W1 of the hydrocarbon wax is 0.5 to 7.0 mass parts per 100 mass parts of the binder resin;
the content W2 of the ester wax is 3.0 to 20.0 mass parts per 100 mass parts of the binder resin; and
the content of the monomer unit corresponding to dodecenylsuccinic acid is 3.0 to 20.0 mass % with reference to the mass of the binder resin.

7. The toner according to claim 1, wherein
the ester wax comprises the monoester compound, and
the monoester compound comprises a compound given by following formula (1)
R¹—COO—R² . . . (1)
(R¹ and R² each independently represent an alkyl group having 18 to 24 carbons.)

8. The toner according to claim 1, wherein the toner particle comprises a compound A that is at least one compound selected from the group consisting of compounds given by following formula (2) and compounds given by following formula (3);
R³—O—(A¹-O)ₙ—X . . . (2)
R⁴-Ph—O—(A²-O)ₘ—X . . . (3)
where, in formula (2), R³ represents an alkyl group having 8 to 24 carbons; A¹ represents an ethylene group or propylene group; n is an integer from 5 to 60; and X is H, CH₂COOH, CH₂SO₃H, CH₂COONa, or CH₂SO₃Na, and,
in formula (3), R⁴ represents an alkyl group having 8 to 24 carbons; Ph represents a phenylene group; A² represents an ethylene group or propylene group; m represents an integer from 5 to 60; and X is H, CH₂COOH, CH₂SO₃H, CH₂COONa, or CH₂SO₃Na.

9. The toner according to claim 8, wherein the amount of extraction of the compound A extracted from the toner using ethanol is 10 to 2,000 ppm.

10. The toner according to claim 1, wherein
in cross-sectional observation of the toner using a transmission electron microscope, when As is an average proportion for an area taken up by domains due to the wax in a surface layer region from a surface of the toner particle to a depth of 200 nm,
the As is 0.0 to 1.0 area %.

11. The toner according to claim 1, wherein
the toner particle comprises a boron atom, and
a content of the boron atom is 1.0 to 100.0 mass-ppm with reference to the mass of the toner particle.

12. The toner according to claim 1, wherein a content of the polyester resin A is 50.0 to 100.0 mass % with reference to the mass of the binder resin.
